(19) United States
(12) Patent Application Publication
(10) Pub. No.: US 2008/0003558 A1
(43) Pub. Date: Jan. 3, 2008

(54) Cognitive Training Using Multiple Stimulus Streams With Response Inhibition

(75) Inventors: Samuel C. Chan, Alameda, CA (US); Joseph L. Hardy, Richmond, CA (US); Michael M. Merzenich, San Francisco, CA (US)

Correspondence Address: HUFFMAN LAW GROUP, P.C., 1900 MESA AVE., COLORADO SPRINGS, CO, 80906, US

(73) Assignee: Posit Science Corporation, San Francisco, CA (US)

(21) Appl. No.: 11/760,500

(22) Filed: Jun. 8, 2007

Related U.S. Application Data
(60) Provisional application No. 60/804,427, filed on Jun. 9, 2006.
(60) Provisional application No. 60/868,839, filed on Dec. 6, 2006.

(51) Int. Cl. G09B 7/00

(52) U.S. Cl. 434/323

(57) ABSTRACT

System and method for enhancing cognition using continuous performance with multiple stimulus streams. A target correspondence is presented. A continuous sequence of stimulus groups is presented one stimulus group at a time, where each stimulus group includes at least two stimuli, and where each stimulus group is presented for a specified duration, and separated by a specified inter-stimulus-interval (ISI). For each stimulus group in the sequence: the subject is required to respond to the group, indicating when all the stimuli in the group correspond in accordance with the target correspondence, and refraining from indicating when the stimuli do not correspond, correctness/incorrectness of the response is determined, and the duration and/or the ISI adjusted accordingly, using an adaptive procedure, e.g., a continuous performance maximum likelihood procedure. The presenting the target correspondence, presenting the sequence of stimulus groups, and the requiring/determining/adjusting for each group, are iterated to improve cognition of the subject.

### CROSS REFERENCE TO RELATED APPLICATION(S)

This application claims the benefit of the following US Provisional Patent Applications, which are incorporated herein in their entirety for all purposes:

| Docket No. | Ser. No. | Filing Date: | Title: |
|---|---|---|---|
| PS.0128 | 60/804,427 | Jun. 9, 2006 | Aristotle 1-3 |
| PS.0131 | 60/868,839 | Dec. 6, 2006 | COMPUTER BASED |
| | | | TRAINING PROGRAM |
| | | | TO IMPROVE SUSTAINED |
| | | | ATTENTION, INHIBITION, |
| | | | WORKING MEMORY |

The following applications are related to the present application, and are hereby incorporated by reference in their entirety for all purposes:

| | | | |
|---|---|---|---|
| PS.0216 | ******* | ******* | COGNITIVE TRAINING USING A |
| | | | CONTINUOUS PERFORMANCE |
| | | | ADAPTIVE PROCEDURE |
| PS.0231 | ******* | ******* | COGNITIVE TRAINING USING |
| | | | ONE OR MORE STIMULUS |
| | | | STREAMS AND TARGET |
| | | | ATTRIBUTE MATCHING |

### FIELD OF THE INVENTION

This invention relates in general to the use of brain health programs utilizing brain plasticity to enhance human performance and correct neurological disorders, and more specifically, to a method for improving cognition using stimulus streams with stimulus response inhibition.

### BACKGROUND OF THE INVENTION

Almost every individual has a measurable deterioration of cognitive abilities as he or she ages. The experience of this decline may begin with occasional lapses in memory in one's thirties, such as increasing difficulty in remembering names and faces, and often progresses to more frequent lapses as one ages in which there is passing difficulty recalling the names of objects, or remembering a sequence of instructions to follow directions from one place to another. Typically, such decline accelerates in one's fifties and over subsequent decades, such that these lapses become noticeably more frequent. This is commonly dismissed as simply “a senior moment” or “getting older.” In reality, this decline is to be expected and is predictable. It is often clinically referred to as “age-related cognitive decline,” or “age-associated memory impairment.” While often viewed (especially against more serious illnesses) as benign, such predictable age-related cognitive decline can severely alter quality of life by making daily tasks (e.g., driving a car, remembering the names of old friends) difficult.

In many older adults, age-related cognitive decline leads to a more severe condition now known as Mild Cognitive Impairment (MCI), in which sufferers show specific sharp declines in cognitive function relative to their historical lifetime abilities while not meeting the formal clinical criteria for dementia. MCI is now recognized to be a likely prodromal condition to Alzheimer's Disease (AD) which represents the final collapse of cognitive abilities in an older adult. The development of novel therapies to prevent the onset of this devastating neurological disorder is a key goal for modern medical science.

The ability to effectively override and inhibit over-learned responses is degraded with advanced age. This deficit occurs due to declines in the inhibitory control system and frontal lobe functions with aging. The net effect on the neural information processing system of this deficit is an overall loss of accuracy, declines in speed of information processing and working memory, and an increase in reaction time. In addition, the ability for selective attention and decision-making is impaired in aging. When a goal requires a novel response that is in competition with a prepotent or highly practiced response, older adults tend to behave more slowly and become more error-prone. The consequences of this can be observed in longer reaction times and higher number of undesired actions. This is caused by a failure to maintain consistent activation toward intended goals.

Safe and rational decision making sometimes requires one to suppress automatic and over-learned responses. In order to make sound and advantageous decisions, one must be able to focus on relevant information and effectively block out irrelevant information, for example, decisions that are based on goals and rewards rather than on emotional responses. Additionally, attentional control and speed of information processing are necessary components for safe driving.

The majority of the experimental efforts directed toward developing new strategies for ameliorating the cognitive and memory impacts of aging have focused on blocking and possibly reversing the pathological processes associated with the physical deterioration of the brain. However, the positive benefits provided by available therapeutic approaches (most notably, the cholinesterase inhibitors) have been modest to date in AD, and are not approved for earlier stages of memory and cognitive loss such as age-related cognitive decline and MCI.

Cognitive training is another potentially potent therapeutic approach to the problems of age-related cognitive decline, MCI, and AD. This approach typically employs computer- or clinician-guided training to teach subjects cognitive strategies to mitigate their memory loss. Although moderate gains in memory and cognitive abilities have been recorded with cognitive training, the general applicability of this approach has been significantly limited by two factors: 1) Lack of Generalization; and 2) Lack of enduring effect.

Lack of Generalization: Training benefits typically do not generalize beyond the trained skills to other types of cognitive tasks or to other “real-world” behavioral abilities. As a result, effecting significant changes in overall cognitive status would require exhaustive training of all relevant abilities, which is typically infeasible given time constraints on training.

Lack of Enduring Effect: Training benefits generally do not endure for significant periods of time following the end of training. As a result, cognitive training has appeared infeasible given the time available for training sessions, particularly from people who suffer only early cognitive impairments and may still be quite busy with daily activities.

As a result of overall moderate efficacy, lack of generalization, and lack of enduring effect, no cognitive training strategies are broadly applied to the problems of age-related cognitive decline, and to date they have had negligible commercial impacts. The applicants believe that a significantly innovative type of training can be developed that will surmount these challenges and lead to fundamental improvements in the treatment of age-related cognitive decline. This innovation is based on a deep understanding of the science of “brain plasticity” that has emerged from basic research in neuroscience over the past twenty years, which only now through the application of computer technology can be brought out of the laboratory and into the everyday therapeutic treatment.

Thus, improved systems and methods for improving cognition and memory are desired.

### SUMMARY

Various embodiments of a system and method for enhancing cognition and memory in a subject via cognitive training exercises using continuous stimuli, i.e., stimulus streams, are presented. Embodiments of the computer-based exercises or tasks described herein may operate to renormalize and improve the ability of the nervous system to perceive, process, and remember, information presented in a continuous manner. This may be achieved by having subjects perform any of various tasks using stimulus streams under conditions of high engagement/stimulation and under high reward for correct performance in order to encourage renormalization of cognition and memory. In some embodiments, the method may be as follows:

A set (or sets) of stimuli may be provided for presentation to the subject. For example, the stimuli may be stored on a memory medium of the computing device, on a memory medium coupled to the computing device, e.g., over a network, etc. The stimuli may include auditory stimuli (sound) and visual stimuli, e.g., orthographic or pictorial. Note that as used herein, a “more difficult stimulus” means that in the context of a cognitive training task, the presentation of the stimulus would result in a lower probability of correct response by the subject.

A target correspondence may be presented to the subject. The target correspondence may be presented visually and/or audibly as desired. In some embodiments, the target correspondence may specify a correspondence condition or criterion (or criteria) for some of the stimuli in the set(s) of stimuli, examples of which are described below.

Note, however, that in various embodiments, the target correspondence may specify any of various matching or correspondence criteria, e.g., target attributes, possibly including the absence of attributes, correspondence condition(s), and so forth, indicating to the subject under what conditions the presented stimuli may be considered to correspond or match. In other words, the target descriptor may specify target attributes and/or relationships among the stimuli, or any combination. It should be noted that any types of target correspondence may be used as desired, e.g., arbitrary attributes of arbitrary stimuli.

A continuous sequence of stimulus groups from the set of stimuli may be presented to the subject one stimulus group at a time, where each stimulus group includes at least two stimuli. Each stimulus group may be presented for a specified duration, and the stimulus groups in the continuous sequence of stimulus groups may be separated by a specified inter-stimulus-interval (ISI). In preferred embodiments, the exercises described herein are performed via a graphical user interface (GUI), and thus, the stimuli may be presented in or by the GUI, e.g., in a visual field. In some embodiments, the stimuli in each stimulus group may be presented in a single mode, e.g., all the stimuli in the group may be presented audibly, all stimuli in the group may be presented orthographically (textually), all the stimuli in the group may be presented pictorially, all the stimuli may be presented visually (which is a super set of orthographic and pictorial), and so forth. In other embodiments, multiple modes may be used. For example, in one embodiment, the stimulus group may include at least one auditory stimulus and at least one visual stimulus. Of course, in other embodiments, any combinations of presentation modes may be used as desired.

Note that in embodiments where each stimulus group includes multiple stimuli, the continuous sequence of stimulus groups includes or corresponds to at least two continuous stimulus streams, where the at least two stimuli in each stimulus group are from respective continuous stimulus streams of the at least two continuous stimulus streams. In other words, each stimulus group includes stimuli from respective stimulus streams, and the presenting of the sequence of stimulus groups includes presenting the stimulus streams to the subject, with each stimulus stream contributing a respective stimulus for each stimulus group. In preferred embodiments, the target correspondence may specify a correspondence condition for at least a subset of the stimulus groups in the sequence of stimulus groups. For example, in an embodiment where an auditory stimulus stream and an orthographic stream are used, one exemplary target correspondence may specify that an auditory stimulus comprising a spoken numeral and a visual stimulus comprising a displayed repeated sequence of numeric digits correspond if the spoken numeral matches the number of repeated digits in the sequence. Thus, for example, the stimulus group may include a spoken “four” indicating a quantity or number of objects, and a displayed numeral “6666”, which in this case, match or correspond, since there are four “6”s. An example of a non-corresponding (non-matching) stimulus group is a spoken “three” and a displayed numeral “33”, since there are two “3”s, not three. Other examples of such stimulus groups are described below.

Each stimulus group in the continuous sequence of stimulus groups may be processed as follows:

The subject may be required to respond to the stimulus group by indicating when all the stimuli in a group correspond in accordance with the target correspondence, and by refraining from indicating when all the stimuli in the group do not correspond in accordance with the target correspondence. Said another way, when all the stimuli in the group match, the subject should indicate that this is so, but when all the stimuli do not match, the subject should refrain from responding. As noted above, “corresponding” or “matching” stimuli, refer to stimuli that correspond to each other in accordance with the target correspondence, e.g., a spoken “four” indicating a quantity or number of objects, and a displayed numeral “6666”, which in this case, match or correspond, since there are four “6”s.

Note that in a preferred multi-mode embodiment, one (or more) auditory stimulus stream(s) may be presented through a sound-generating device (e.g., speakers or headphones), and one (or more) visual stimulus stream(s) may be presented on a visual display device, e.g., a computer monitor, where the subject may be required to respond when the auditory stimulus matches the stimulus on the screen, e.g., by pressing the spacebar on the keyboard (or other indication means, e.g., via a GUI control).

In one exemplary single-mode (visual) example, the target correspondence may be “global triangle”, and the stimulus group may comprise an arrangement of small shapes, e.g., a plurality of small circles in the shape of a triangle, in which case the stimulus group does correspond in accordance with the target correspondence. In a case where the stimulus group comprises a plurality of small triangles in the shape of a square, the stimulus group would not correspond in accordance with the target correspondence. Note that in various embodiments, the plurality of small shapes may be considered to be a single stimulus (an arrangement of shapes), or may be considered to be multiple stimuli in a stimulus group, where each small shape is from a respective stimulus stream.

Thus, in some embodiments, the stimulus groups may be presented in a single mode, e.g., all visual (e.g., all orthographic, all pictorial, etc.), all auditory, etc.

A determination may be made as to whether the subject responded correctly for the stimulus group. For example, in some embodiments, the subject's response to the stimulus group may include one of: a correct response, including a true positive, where the subject correctly indicates when all the stimuli in the stimulus group correspond in accordance with the target correspondence, or a true negative, where the subject correctly refrains from indicating when all the stimuli in the stimulus group do not correspond in accordance with the target correspondence, or an incorrect response, including: a false negative, where the subject fails to indicate when all the stimuli in the stimulus group correspond in accordance with the target correspondence, or a false positive, where the subject incorrectly indicates that all the stimuli in the stimulus group correspond in accordance with the target correspondence. In other words, if the stimuli correspond or match in accordance with the target correspondence, the correct response is to indicate the correspondence or match, and the incorrect response is to fail to indicate the correspondence or match, and if the stimuli do not correspond or match in accordance with the target correspondence, the correct response is to refrain from indicating a correspondence or match, and the incorrect response is to (incorrectly) indicate that the stimuli correspond or match in accordance with the target correspondence. In one embodiment, a true positive may require that the subject correctly indicate when all the stimuli in the stimulus group correspond in accordance with the target correspondence before a next stimulus group is presented, i.e., before the stimulus group's ISI has elapsed. This time period between the moment the stimulus group is presented and the onset of the subsequent stimulus group is referred to as the window of response, and may be modified per trial. In other words, the response window is the duration of the stimulus presentation plus the following ISI time.

In some embodiments, an indication, e.g., an audible or visual indication, may be provided to the subject indicating whether the subject responded correctly, i.e., indicating the correctness or incorrectness of the subject's response. For example, in one embodiment, a “ding” or a “thunk” (or corresponding equivalents) may be played to indicate correctness or incorrectness, respectively. In some embodiments, indicating whether the subject responded correctly may include rewarding the subject if a specified level of success is achieved, or penalizing the subject if a specified level of failure is achieved, where the rewarding and penalizing may each include one or more of: auditory feedback, visual feedback, point modification, or change in bonus status. Of course, any types of indication may be used as desired, e.g., graphical images, animation, audible rewards, e.g., tunes, etc.

The duration and/or the ISI may be adjusted based on the above determining. For example, if the subject achieves some specified level of success, the duration and/or ISI may be decreased, thereby increasing the difficulty of the task. Conversely, if the subject has achieved some specified level of failure (or failed to achieve a (possibly different) level of success, the duration and/or ISI may be increased, thereby decreasing the difficulty of the task. In preferred embodiments, adjusting the duration and/or the ISI may be performed using an adaptive procedure, e.g., a maximum likelihood procedure. For example, the maximum likelihood procedure may be or include a QUEST (quick estimation by sequential testing) threshold procedure, or a ZEST (zippy estimation by sequential testing) threshold procedure, described below, whereby threshold values for the stimulus duration and/or ISI (or more generally, the stimulus intensity) may be determined based on the subject's performance. In preferred embodiments, a continuous performance maximum likelihood procedure may be used, e.g., continuous performance ZEST or continuous performance QUEST. However, it should be noted that in various embodiments, any adaptive procedure may be used as desired.

In some embodiments, adjusting the stimulus duration and/or ISI may include adjusting the stimulus duration and/or ISI to approach and substantially maintain a specified success rate for the subject, e.g., using a single stair continuous performance maximum likelihood procedure.

In one embodiment, the above presenting, and processing each stimulus, including the requiring, determining, and adjusting, for each stimulus group may compose a session. For each session, an initial value of the duration and/or the ISI and a final value of the duration and/or the ISI may be averaged to determine the initial value of the duration and/or the ISI for the next session. In some embodiments, for each session, reaction times (of the subject) may be averaged for each stimulus group in the continuous sequence of stimulus groups to determine a minimum value for the duration and/or the ISI for the next session, where each reaction time includes a respective delay between the presentation of each stimulus group and the subject's response to the stimulus group. In some embodiments, at the end of each session a reward may be presented, e.g., visually and/or audibly.

In one embodiment, each stimulus group presentation and corresponding subject response may compose a trial. The method may further include for each trial, recording one or more of: the stimulus group, whether or not the stimulus group corresponds in accordance with the target correspondence, the duration, the ISI, the subject's response, the correctness or incorrectness of the subject's response, the reaction time for the trial, or statistical measures for the adaptive procedure, e.g., the continuous performance maximum likelihood procedure.

In some embodiments, the above presenting, and processing each stimulus, including the requiring, determining, and adjusting, for each stimulus, may be iteratively performed to improve the cognition of the subject, e.g., presenting various stimulus group sequences (stimulus streams), and adjusting the stimulus presentation to increase or decrease the task difficulty based on the subject's responses. In some embodiments, the repeating may be terminated if the subject responds incorrectly a specified number of times consecutively, e.g., 5 times in a row.

In some embodiments, the above presenting, and processing each stimulus may be performed under a specified condition, where the condition specifies one or more attributes of the presenting the continuous sequence(s) of stimulus groups. Moreover, the method may further include performing the repeating a plurality of times, i.e., iteratively, where each iteration is performed under a respective condition. In other words, not only may multiple continuous sequences groups of stimuli be presented (the repeating of the presenting and processing of each stimulus group), but a plurality of such multiple presentations may be performed as well, each under a respective condition.

In one embodiment, each condition may specify one or more of: session length, e.g., length of the continuous sequence of stimulus groups, and/or length of time of said presenting the continuous sequence of stimulus groups, correspondence frequency, e.g., a ratio of stimulus groups in which all the stimuli correspond in accordance with the target correspondence to stimulus groups in which all the stimuli do not correspond in accordance with the target correspondence (may be shortened or randomized to test subject's ability to focus attention and recall targets in various frequencies), or target/foil confusability, e.g., a degree to which stimuli that correspond in accordance with the target correspondence are similar to stimuli that do not correspond in accordance with the target correspondence. In other embodiments, other attributes may be used as desired.

As noted above, in some embodiments, the conditions may become more difficult as the subject progresses through the exercise. Moreover, the exercise may include various continuous performance tasks, where different types or categories of stimuli may be used, exemplary embodiments of which are described below.

The following describes various exemplary embodiments of continuous performance response inhibition tasks, following the method described above. Note that the tasks described below are exemplary only, and are not intended to limit the exercise to any particular set of tasks or types of stimuli.

In one exemplary task (referred to herein as Task 1 for convenience), the stimulus group is multi-modal, where the stimulus group includes at least one auditory stimulus and at least one visual stimulus. In this example task, the at least one auditory stimulus includes a spoken numeral, and the at least one visual stimulus includes a displayed one or more instances of a digit. Note that as used herein, “spoken” may refer to a human recording, or synthesized speech. The target correspondence or match criterion requires the number of displayed digits, e.g., a sequence of 5s, to be equal to the spoken numeral, where the value of the digit may serve to confuse the subject, particularly if the value is equal to that of the spoken numeral. For example, in one embodiment, the subject may hear a numeral (the spoken numeral) and see a digit singly or repeated up to six times. The task is to indicate when the spoken numeral matches the number of digits presented. Foil stimuli (i.e., stimuli that do not correspond or match in accordance with the target correspondence) include strings where the value of the displayed digit(s) is equal to the spoken numeral, but the number of digits in the string is not. Thus, the subject should inhibit their response to the semantic number represented by the digit (or indicate a non-match) even though it matches the spoken number. Note that the value of the digit may serve to confuse the subject, particularly if the value is equal to that of the spoken numeral. For example, a string of three 2s may appear on the screen coincident with the audio presentation of the word “two”. This is a mismatch requiring the subject to inhibit their response to the 2s displayed on the screen.

In another exemplary task (referred to herein as Task 2 for convenience), the stimulus group is multi-modal, where the stimulus group includes at least one auditory stimulus and at least one visual stimulus, as with Task 1. In this example task, the at least one auditory stimulus includes a spoken color, and the at least one visual stimulus includes a displayed color name, printed (i.e., displayed) in a color, i.e., the displayed word is colored. The target correspondence or match criterion requires the color of the word (not the named color) to match or correspond to the spoken color, where the spelled color (i.e., the meaning of the word) may serve to confuse the subject, particularly if the spelled color is equal to that of the spoken color. For example, in one embodiment, the subject may hear a color and see a word printed in a color. The task is to indicate when the spoken color matches or corresponds to the color of the word (not the spelled color). Thus, the subject should inhibit their response to the color spelled out by the word (or indicate a non-match). For example, the word “yellow” printed in blue may appear on the screen coincident with the audio presentation of the word “yellow”. This is a mismatch requiring the subject to inhibit their response to the semantic meaning of the printed word (or indicate a non-match).

In another exemplary task (referred to herein as Task 3 for convenience), the stimulus group is multi-modal, where the stimulus group includes at least one auditory stimulus and at least one visual stimulus, as with Task 1. In this example task, the at least one auditory stimulus includes a spoken alphanumeric character, e.g., a letter, and the at least one visual stimulus includes a displayed string of alphanumeric characters, e.g., letters, for example, seven letters, including a middle letter with repetitive sequences of another letter preceding and succeeding the middle letter, e.g., three Xs, followed by an A, followed by three more Xs. In this exemplary embodiment, the target correspondence or match criterion requires the middle letter in the string to match or correspond to the spoken letter, where the preceding and succeeding letters, referred to as the surrounding letters, may serve to confuse the subject, particularly if the surrounding letters match the spoken letter. For example, in one embodiment, the subject may hear a letter spoken and see a string of seven letters displayed on the screen. The task is to indicate when the spoken letter corresponds with or matches the letter in the middle of the string of letters. As noted above, in one embodiment, the string includes the same letter repeated six times with a different letter displayed in the center. The subject should inhibit their response to the six letters repeated on either side of the middle letter. Note that numerals may also be used, e.g., the auditory stimulus may be a spoken numeral, and the visual stimulus may be first displayed numeral, surrounded by a string (i.e., repetitive sequence) of a second numeral, e.g., “3335333”. Thus, in various embodiments, the task may utilize strings of alphanumeric characters as desired.

In another exemplary task (referred to herein as Task 4 for convenience), the stimulus group is multi-modal, where the stimulus group includes at least one auditory stimulus and at least one visual stimulus. In this example task, the at least one auditory stimulus includes a spoken direction, and the at least one visual stimulus includes a displayed graphical arrow with a direction (word) printed within, e.g., “up”, “down”, “left”, or “right”. The target correspondence or match criterion requires the direction indicated by the arrow (not the printed word) to match or correspond to the spoken direction, where the printed word may serve to confuse the subject, particularly if the printed word is the same as the spoken direction. For example, in one embodiment, the subject may hear a direction spoken and see an arrow displayed on the screen. The task is to indicate a correspondence when the spoken direction corresponds with or matches the direction in which the arrow points. The subject should inhibit their response to the direction printed (written or displayed) within the arrow (or indicate a non-match).

In another exemplary task (referred to herein as Task 5 for convenience), the stimulus group is single-modal, where the target correspondence comprises a global shape descriptor, the at least two stimuli comprises an arrangement of graphical elements, and the stimulus group corresponds if the arrangement of graphical elements forms the global shape. In one example of this exemplary single-mode task, the target correspondence may be “global triangle”, and the stimulus group may comprise an arrangement of small shapes, e.g., a plurality of small circles in the shape of a triangle, in which case the stimulus group does correspond in accordance with the target correspondence. In a case where the stimulus group comprises a plurality of small triangles in the shape of a square, the stimulus group would not correspond in accordance with the target correspondence. Note that in various embodiments, the plurality of small shapes may be considered to be a single stimulus (an arrangement of shapes), or may be considered to be multiple stimuli in a stimulus group, where each small shape is from a respective stimulus stream. Stimuli in other single modes are also contemplated, e.g., multiple sounds, melodies, and so forth, as mentioned above.

In some embodiments, the exercise may include a combination of the above tasks (possibly including other continuous performance tasks, as well).

In some embodiments, the repeating, and/or the performing the repeating a plurality of times, may occur a specified number of times each day, for a specified number of days. In other words, the subject may perform a plurality of sessions each day over a period of days, e.g., for 6 months, to improve cognition.

Other features and advantages of the present invention will become apparent upon study of the remaining portions of the specification and drawings.

### BRIEF DESCRIPTION OF THE DRAWINGS

FIG. 1 is a block diagram of a computer system for executing a program according to some embodiments of the present invention;

FIG. 2 is a block diagram of a computer network for executing a program according to some embodiments of the present invention;

FIG. 3 is a high-level flowchart of one embodiment of a method for cognitive training using stimulus streams with response inhibition, according to one embodiment;

FIG. 4 illustrates an exemplary response inhibition task using auditory and visual numbers, according to one embodiment;

FIG. 5 illustrates an exemplary response inhibition task using auditory and visual colors, according to one embodiment;

FIG. 6 illustrates an exemplary response inhibition task using auditory and visual letters, according to one embodiment;

FIG. 7 illustrates an exemplary response inhibition task using auditory and visual directions, according to one embodiment;

FIG. 8A illustrates an exemplary screenshot of a graphical user interface with instructions and a presented target correspondence, according to one embodiment;

FIG. 8B illustrates an exemplary screenshot of a graphical user interface with a presented stimulus, according to one embodiment;

FIG. 9A illustrates another exemplary screenshot of a graphical user interface with instructions and another presented target correspondence, according to one embodiment;

FIG. 9B illustrates an exemplary screenshot of a graphical user interface indicating a correct response to a trial, according to one embodiment;

FIG. 9C illustrates an exemplary screenshot of a graphical user interface indicating an incorrect response to a trial, according to one embodiment;

FIG. 10 illustrates an exemplary psychometric function based on a cumulative Gaussian distribution for a detection (yes/no) task with a 5% lapsing rate, and a target performance rate of 85%, according to one embodiment;

FIG. 11 illustrates an exemplary probability density function with initial intensity estimate x=5, according to one embodiment;

FIG. 12 illustrates exemplary likelihood functions with T=5 and an 85% correct rate, according to one embodiment;

FIG. 13 illustrates an exemplary prior probability density function (P.D.F.) superimposed with exemplary likelihood functions, according to one embodiment; and

FIG. 14 illustrates an exemplary posterior P.D.F. with Yes/No response, according to one embodiment.

### DETAILED DESCRIPTION

Below are described various embodiments of a system and method for continuous performance cognitive training using stimulus streams.

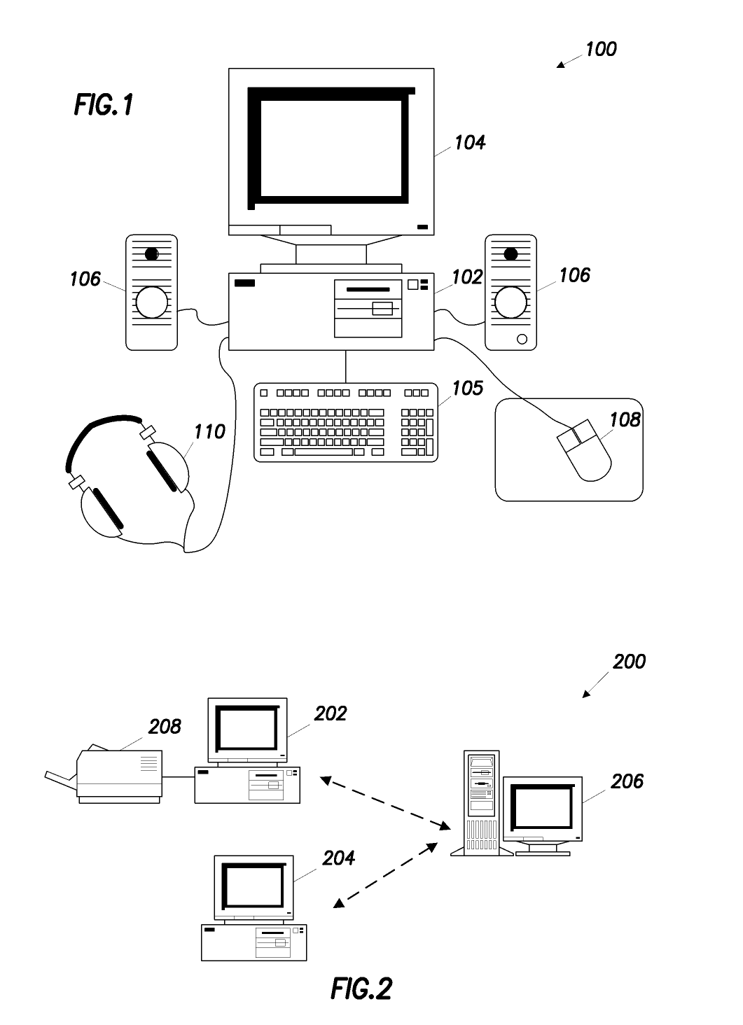

Referring to FIG. 1, a computer system 100 is shown for executing a computer program to train, or retrain an individual according to the present invention to enhance cognition, where the term “cognition” refers to the speed, accuracy and reliability of processing of information, and attention and/or memory, and where the term “attention” refers to the facilitation of a target and/or suppression of a non-target, e.g., over a given spatial extent, object-specific area, or time window, e.g., with respect to one or more stimulus streams, such as in a continuous performance exercise. As shown, in this embodiment, the computer system 100 contains a computer 102, having a CPU, memory, hard disk and CD ROM drive (not shown), attached to a monitor 104. The monitor 104 provides visual prompting and feedback to the subject during execution of the computer program. Attached to the computer 102 are a keyboard 105, speakers 106, a mouse 108, and headphones 110. In some embodiments, the speakers 106 and the headphones 110 may provide auditory prompting, stimuli, and feedback to the subject during execution of the computer program. The mouse 108 allows the subject to navigate through the computer program, and to select particular responses after visual or auditory prompting by the computer program. The keyboard 105 allows an instructor to enter alphanumeric information about the subject into the computer 102, and/or response by the subject. Although a number of different computer platforms are applicable to the present invention, embodiments of the present invention execute on either IBM compatible computers or Macintosh computers, or similarly configured computing devices such as set top boxes, PDA's, gaming consoles, etc.

Now referring to FIG. 2, a computer network 200 is shown. The computer network 200 contains computers 202, 204, similar to that described above with reference to FIG. 1, connected to a server 206. The connection between the computers 202, 204 and the server 206 can be made via a local area network (LAN), a wide area network (WAN), or via modem connections, directly or through the Internet. A printer 208 is shown connected to the computer 202 to illustrate that a subject can print out reports associated with the computer program of the present invention. The computer network 200 allows information such as test scores, game statistics, and other subject information to flow from a subject's computer 202, 204 to a server 206. An administrator can review the information and can then download configuration and control information pertaining to a particular subject, back to the subject's computer 202, 204.

Embodiments of the computer-based exercises or tasks described herein may operate to renormalize and improve the ability of the nervous system to perceive, process, and remember, information via continuous performance using stimulus streams. This may be achieved by having subjects perform any of various tasks using stimuli under conditions of high engagement/stimulation and under high reward for correct performance in order to encourage renormalization of cognition, and memory.

More specifically, embodiments of the systems and methods presented herein may be used to train subjects to maintain attention and vigilance on two or more streams of information, e.g., stimulus streams. In a preferred embodiment, two streams may be used: auditory and visual, although it should be noted that in some embodiments, multiple streams may be presented in each category. The concurrent use of two stimulus categories is referred to as “bimodal”. In further embodiments, additional stimulus stream categories (or sub-categories) may be used instead of, or in addition to, auditory and visual, e.g., orthographic, pictorial, etc. As the stimulus streams are presented, the subject is to respond positively when presented with a match between the two (or more) streams while inhibiting positive response when non-matches are presented. As subjects progress through the exercise, the presentation duration and/or the inter-stimulus-interval (ISI) of the stimuli may be shortened to require quicker and more accurate responses from the subject. Additionally, over the course of the exercise, stimulus streams may be presented under a variety of conditions, described below, where the conditions may become more difficult as the subject progresses through the exercise. Moreover, the exercise may include various continuous performance tasks, where different types or categories of stimuli may be used, also described below.

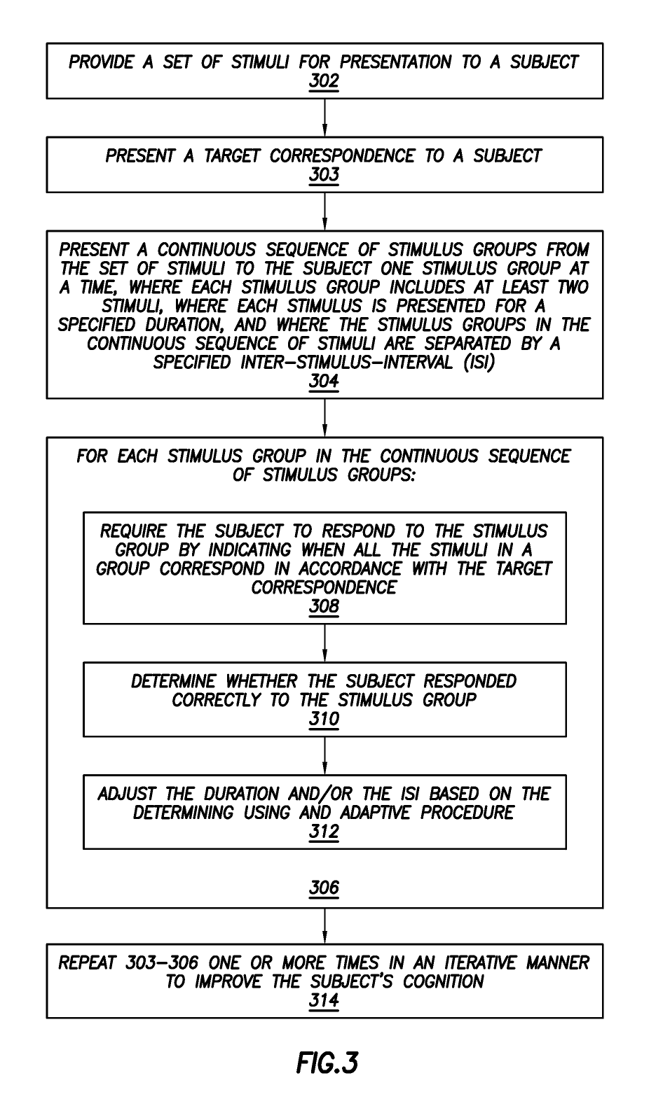

FIG. 3—Flowchart of a Method for Cognitive Training Using Continuous Performance

FIG. 3 is a high-level flowchart of one embodiment of a method for cognitive training using continuous stimuli, i.e., stimulus streams. More specifically, the method utilizes a computing device to present one or more stimulus streams, and to record responses from the subject. A primary goal of this method is to challenge subjects to engage in an attentional control and response inhibition task that requires processing, goal maintenance and comparison between multiple ongoing streams of information. The method may be used in the context of any of a variety of cognitive training exercises using continuous performance with stimulus streams, examples of which are described below. It should be noted that in various embodiments, some of the method elements may be performed concurrently, in a different order than shown, or may be omitted. Additional method elements may also be performed as desired. As shown, the method may be performed as follows:

In 302, a set (or sets) of stimuli may be provided for presentation to the subject. For example, the stimuli may be stored on a memory medium of the computing device, on a memory medium coupled to the computing device, e.g., over a network, etc. The stimuli may include auditory stimuli (sound) and visual stimuli, e.g., orthographic or pictorial. Note that as used herein, a “more difficult stimulus” means that in the context of a cognitive training task, the presentation of the stimulus would result in a lower probability of correct response by the subject.

In 303, a target correspondence may be presented to the subject. The target correspondence may be presented visually and/or audibly as desired. In some embodiments, the target correspondence may specify a correspondence condition or criterion (or criteria) for some of the stimuli in the set(s) of stimuli, examples of which are described below.

Note, however, that in various embodiments, the target correspondence may specify any of various matching or correspondence criteria, e.g., target attributes, possibly including the absence of attributes, correspondence condition(s), and so forth, indicating to the subject under what conditions the presented stimuli may be considered to correspond or match. In other words, the target descriptor may specify target attributes and/or relationships among the stimuli, or any combination. It should be noted that any types of target correspondence may be used as desired, e.g., arbitrary attributes of arbitrary stimuli.

In 304, a continuous sequence of stimulus groups from the set of stimuli may be presented to the subject one stimulus group at a time. In preferred embodiments, each stimulus group includes at least two stimuli, although in some embodiments, a stimulus group may comprise a single stimulus. Each stimulus group may be presented for a specified duration, and the stimulus groups in the continuous sequence of stimulus groups may be separated by a specified inter-stimulus-interval (ISI). In preferred embodiments, the exercises described herein are performed via a graphical user interface (GUI), and thus, the stimuli may be presented in or by the GUI, e.g., in a visual field, examples of which are described below. In some embodiments, the stimuli in each stimulus group may be presented in a single mode, e.g., all the stimuli in the group may be presented audibly, all stimuli in the group may be presented orthographically (textually), all the stimuli in the group may be presented pictorially, all the stimuli may be presented visually (which is a super set of orthographic and pictorial), and so forth. In other embodiments, multiple modes may be used. For example, in one embodiment, the stimulus group may include at least one auditory stimulus and at least one visual stimulus. Of course, in other embodiments, any combinations of presentation modes may be used as desired.

Note that in embodiments where each stimulus group includes multiple stimuli, the continuous sequence of stimulus groups includes or corresponds to at least two continuous stimulus streams, where the at least two stimuli in each stimulus group are from respective continuous stimulus streams of the at least two continuous stimulus streams. In other words, each stimulus group includes stimuli from respective stimulus streams, and the presenting of the sequence of stimulus groups includes presenting the stimulus streams to the subject, with each stimulus stream contributing a respective stimulus for each stimulus group. In preferred embodiments, the target correspondence may specify a correspondence condition for at least a subset of the stimulus groups in the sequence of stimulus groups. For example, in an embodiment where an auditory stimulus stream and an orthographic stream are used, one exemplary target correspondence may specify that an auditory stimulus comprising a spoken numeral and a visual stimulus comprising a displayed repeated sequence of numeric digits correspond if the spoken numeral matches the number of repeated digits in the sequence. Thus, for example, the stimulus group may include a spoken “four” indicating a quantity or number of objects, and a displayed numeral “6666”, which in this case, match or correspond, since there are four “6”s. An example of a non-corresponding (non-matching) stimulus group is a spoken “three” and a displayed numeral “33”, since there are two “3”s, not three. Other examples of such stimulus groups are described below.

As FIG. 3 indicates, in 306, each stimulus group in the continuous sequence of stimulus groups may be processed as follows (308-312):

In 308, the subject may be required to respond to the stimulus group by indicating when all the stimuli in a group correspond in accordance with the target correspondence, and by refraining from indicating when all the stimuli in the group do not correspond in accordance with the target correspondence. Said another way, when all the stimuli in the group match, the subject should indicate that this is so, but when all the stimuli do not match, the subject should refrain from responding. As noted above, “corresponding” or “matching” stimuli, refer to stimuli that correspond to each other in accordance with the target correspondence, e.g., a spoken “four”, indicating a quantity or number of objects, and a displayed numeral “6666”, which match or correspond, since there are four “6”s. Other examples of such stimulus groups are described below.

Note that in a preferred multi-mode embodiment, one (or more) auditory stimulus stream(s) may be presented through a sound-generating device (e.g., speakers or headphones), and one (or more) visual stimulus stream(s) may be presented on a visual display device, e.g., a computer monitor, where the subject may be required to respond when the auditory stimulus matches the stimulus on the screen, e.g., by pressing the spacebar on the keyboard (or other indication means, e.g., via a GUI control).

In one exemplary single-mode example, the target correspondence may be “global triangle”, and the stimulus group may comprise an arrangement of small shapes, e.g., a plurality of small circles in the shape of a triangle, in which case the stimulus group does correspond in accordance with the target correspondence. In a case where the stimulus group comprises a plurality of small triangles in the shape of a square, the stimulus group would not correspond in accordance with the target correspondence. Note that in various embodiments, the plurality of small shapes may be considered to be a single stimulus (an arrangement of shapes), or may be considered to be multiple stimuli in a stimulus group, where each small shape is from a respective stimulus stream.

Thus, in some embodiments, the stimulus groups may be presented in a single mode, e.g., all visual (e.g., all orthographic, all pictorial, etc.), all auditory, etc.

In 310, a determination may be made as to whether the subject responded correctly for the stimulus group. For example, in some embodiments, the subject's response to the stimulus group may include one of: a correct response, including a true positive, where the subject correctly indicates when all the stimuli in the stimulus group correspond in accordance with the target correspondence, or a true negative, where the subject correctly refrains from indicating when all the stimuli in the stimulus group do not correspond in accordance with the target correspondence, or an incorrect response, including: a false negative, where the subject fails to indicate when all the stimuli in the stimulus group correspond in accordance with the target correspondence, or a false positive, where the subject incorrectly indicates that all the stimuli in the stimulus group correspond in accordance with the target correspondence. In other words, if the stimuli correspond or match in accordance with the target correspondence, the correct response is to indicate the correspondence or match, and the incorrect response is to fail to indicate the correspondence or match, and if the stimuli do not correspond or match in accordance with the target correspondence, the correct response is to refrain from indicating a correspondence or match, and the incorrect response is to (incorrectly) indicate that the stimuli correspond or match in accordance with the target correspondence. In one embodiment, a true positive may require that the subject correctly indicate when all the stimuli in the stimulus group correspond in accordance with the target correspondence before a next stimulus group is presented, i.e., before the stimulus group's ISI has elapsed. This time period between the moment the stimulus group is presented and the onset of the subsequent stimulus group is referred to as the window of response, and may be modified per trial. In other words, the response window is the duration of the stimulus presentation plus the following ISI time.

In some embodiments, an indication, e.g., an audible or visual indication, may be provided to the subject indicating whether the subject responded correctly, i.e., indicating the correctness or incorrectness of the subject's response. For example, in one embodiment, a “ding” or a “thunk” (or corresponding equivalents) may be played to indicate correctness or incorrectness, respectively. In some embodiments, indicating whether the subject responded correctly may include rewarding the subject if a specified level of success is achieved, or penalizing the subject if a specified level of failure is achieved, where the rewarding and penalizing may each include one or more of: auditory feedback, visual feedback, point modification, or change in bonus status. Of course, any types of indication may be used as desired, e.g., graphical images, animation, audible rewards, e.g., tunes, etc.

In 312, the duration and/or the ISI may be adjusted based on the determining of 308. For example, if the subject achieves some specified level of success, the duration and/or ISI may be decreased, thereby increasing the difficulty of the task. Conversely, if the subject has achieved some specified level of failure (or failed to achieve a (possible different) level of success, the duration and/or ISI may be increased, thereby decreasing the difficulty of the task. In preferred embodiments, adjusting the duration and/or the ISI may be performed using an adaptive procedure, e.g., a maximum likelihood procedure. For example, the maximum likelihood procedure may be or include a QUEST (quick estimation by sequential testing) threshold procedure, or a ZEST (zippy estimation by sequential testing) threshold procedure, described below, whereby threshold values for the stimulus duration and/or ISI (or more generally, the stimulus intensity) may be determined based on the subject's performance. In preferred embodiments, a continuous performance maximum likelihood procedure may be used, e.g., continuous performance ZEST or continuous performance QUEST. However, it should be noted that in various embodiments, any adaptive procedure may be used as desired.

In some embodiments, adjusting the stimulus duration and/or ISI may include adjusting the stimulus duration and/or ISI to approach and substantially maintain a specified success rate for the subject, e.g., using a single stair continuous performance maximum likelihood procedure, also described below.

In one embodiment, the method elements 303-306 (including 308-312) may compose a session. In other words, the above presenting the target correspondence (303), presenting the continuous sequence of stimulus groups (304), and processing each stimulus group (306), including the requiring (308), determining (310), and adjusting (312) for each stimulus group may compose a session. For each session, an initial value of the duration and/or the ISI and a final value of the duration and/or the ISI may be averaged to determine the initial value of the duration and/or the ISI for the next session. In some embodiments, for each session, reaction times (of the subject) may be averaged for each stimulus group in the continuous sequence of stimulus groups to determine a minimum value for the duration and/or the ISI for the next session, where each reaction time includes a respective delay between the presentation of each stimulus group in which all the stimuli correspond in accordance with the target correspondence and the subject's response to the stimulus group. In some embodiments, at the end of each session a reward may be presented, e.g., visually and/or audibly.

In some embodiments, the method may further include performing an initial session prior to performing 303-306, where the initial session includes 303-306, but where, in performing 306 in the initial session, neither the duration nor the ISI is adjusted.

In one embodiment, each stimulus group presentation and corresponding subject response may compose a trial. The method may further include for each trial, recording one or more of: the target descriptor, the stimulus group, whether or not the stimulus group corresponds to the target descriptor, the duration, the ISI, the subject's response, the correctness or incorrectness of the subject's response, the reaction time for the trial, or statistical measures for the adaptive procedure, e.g., the continuous performance maximum likelihood procedure, described in more detail below.

In 314, the method elements 303-306 (including 308-312) may be repeated one or more times in an iterative manner to improve the cognition of the subject. In other words, the above presenting the target correspondence (303), presenting the continuous sequence of stimulus groups (304), and processing each stimulus group (306), including the requiring (308), determining (310), and adjusting (312) for each stimulus group, may be iteratively performed to improve the cognition of the subject, e.g., presenting various stimulus group sequences (stimulus streams), and adjusting the stimulus presentation to increase or decrease the task difficulty based on the subject's responses. In some embodiments, the repeating of 314 may be terminated if the subject responds incorrectly a specified number of times consecutively, e.g., 5 times in a row.

In some embodiments, the above method elements 303-306 may be performed under a specified condition, where the condition specifies one or more attributes of the presenting the continuous sequence(s) of stimulus groups. Moreover, the method may further include performing the repeating of 314 a plurality of times, i.e., iteratively, where each iteration is performed under a respective condition. In other words, not only may multiple continuous sequences groups of stimuli be presented (the repeating of 314), but a plurality of such multiple presentations may be performed as well, each under a respective condition.

In one embodiment, each condition may specify one or more of: session length, e.g., length of the continuous sequence of stimulus groups, and/or length of time of said presenting the continuous sequence of stimulus groups, correspondence frequency, e.g., a ratio of stimulus groups in which all the stimuli correspond in accordance with the target correspondence to stimulus groups in which all the stimuli do not correspond in accordance with the target correspondence (may be shortened or randomized to test subject's ability to focus attention and recall targets in various frequencies), or target/foil confusability, e.g., a degree to which stimuli that correspond in accordance with the target correspondence are similar to stimuli that do not correspond in accordance with the target correspondence. In other embodiments, other attributes may be used as desired.

As noted above, in some embodiments, the conditions may become more difficult as the subject progresses through the exercise. For example, various conditions or types of target correspondence may correspond to different progressive levels in the exercise, through which the subject may progress as the exercise or task is performed. For example, more difficult stimuli, more complex target correspondences, shorter presentation times, etc., may be used to define blocks or levels of increasing difficulty.

Moreover, the exercise may include various continuous performance tasks, where different types or categories of stimuli may be used, exemplary embodiments of which are described below.

Exemplary Embodiments of Continuous Performance Response Inhibition Tasks

The following describes various exemplary embodiments of continuous performance response inhibition tasks, following the method of FIG. 3, described above. Note that the tasks described below are exemplary only, and are not intended to limit the exercise to any particular set of tasks, target correspondences, or types of stimuli.

Task 1: Number of Objects Shown is Number Spoken

In one exemplary task (referred to herein as Task 1 for convenience), the stimulus group is multi-modal, where the stimulus group includes at least one auditory stimulus and at least one visual stimulus. In this example task, the at least one auditory stimulus includes a spoken numeral, and the at least one visual stimulus includes a displayed one or more instances of a digit. Note that as used herein, “spoken” may refer to a human recording, or synthesized speech. In this exemplary task, the target correspondence or match criterion requires the number of displayed digits, e.g., a sequence of 5s, to be equal to the spoken numeral, where the value of the digit may serve to confuse the subject, particularly if the value is equal to that of the spoken numeral. For example, in one embodiment, the subject may hear a numeral (the spoken numeral) and see a digit singly or repeated up to six times. The task is to indicate when the spoken numeral matches the number of digits presented. Foil stimuli (i.e., stimuli that do not correspond or match in accordance with the target correspondence) include strings where the value of the displayed digit(s) is equal to the spoken numeral, but the number of digits in the string is not. Thus, the subject should inhibit their response to the semantic number represented by the digit (or indicate a non-match) even though it matches the spoken number. Note that the value of the digit may serve to confuse the subject, particularly if the value is equal to that of the spoken numeral. For example, a string of three 2s may appear on the screen coincident with the audio presentation of the word “two”. This is a mismatch requiring the subject to inhibit their response to the 2s displayed on the screen (or indicate that the stimulus group does not match).

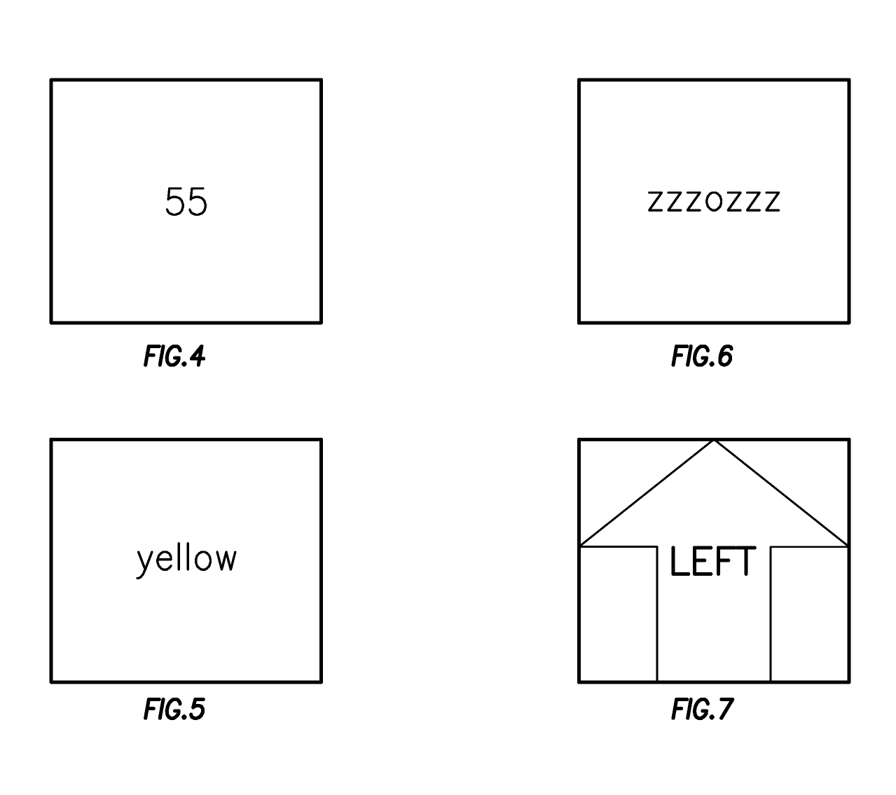

FIG. 4 illustrates an example display of a visual stimulus where a string of two 5s is presented (thus, corresponding to or matching a spoken “two”). Thus, in this case, if the auditory stimulus were a spoken “two”, the subject should indicate correspondence, i.e., a match, but if the auditory stimulus is not a spoken “two”, the subject should refrain from indicating such.

In one embodiment, the auditory and visual stimuli may be restricted in form and/or content to some specified set of stimuli. For example, each stimulus in the audio stream may be restricted to one of the numerals: one, two, three, four, five, or six, spoken once, and each stimulus in the visual stream may be restricted to a single digit between 1 and 6 (inclusive) repeated from one to six times (meaning forming a string of 1-6 instances of the digit). Note however, that in different embodiments, any sets of numerals/digits and any string lengths may be used as desired.

Task 2: Color of Object Shown is Color Spoken

In another exemplary task (referred to herein as Task 2 for convenience), the stimulus group is multi-modal, where the stimulus group includes at least one auditory stimulus and at least one visual stimulus, as with Task 1. In this example task, the at least one auditory stimulus includes a spoken color, and the at least one visual stimulus includes a displayed color name, printed (i.e., displayed) in a color, i.e., the displayed word is colored. In this exemplary task, the target correspondence or match criterion requires the color of the word (not the named color) to match or correspond to the spoken color, where the spelled color (i.e., the meaning of the word) may serve to confuse the subject, particularly if the spelled color is equal to that of the spoken color. For example, in one embodiment, the subject may hear a color and see a word printed in a color. The task is to indicate when the spoken color matches or corresponds to the color of the word (not the spelled color). Thus, the subject should inhibit their response to the color spelled out by the word. For example, the word “yellow” printed in blue may appear on the screen coincident with the audio presentation of the word “yellow”. This is a mismatch requiring the subject to inhibit their response to the semantic meaning of the printed word (or indicate that the stimulus group does not match).

FIG. 5 illustrates an example display of a visual stimulus where the word “yellow” is presented in blue (thus, corresponding to or matching a spoken “blue”). Thus, in this case, if the auditory stimulus were a spoken “blue”, the subject should indicate correspondence, i.e., a match, but if the auditory stimulus is not a spoken “blue”, the subject should refrain from indicating such (or indicate that the stimulus group does not match).

As with the above tasks, in one embodiment, the auditory and visual stimuli may be restricted in form and/or content to some specified set of stimuli. For example, each stimulus in the audio stream may be restricted to one of the colors: brown, red, yellow, blue, green, or purple, spoken once, and each stimulus in the visual stream may be restricted to the words brown, red, yellow, blue, green, or purple, printed in one of these six colors. Note however, that in different embodiments, any sets of colors may be used as desired.

Task 3: Middle Character of String Shown is Character Spoken

In another exemplary task (referred to herein as Task 3 for convenience) the stimulus group is also multi-modal, where the stimulus group includes at least one auditory stimulus and at least one visual stimulus. In this example task, the at least one auditory stimulus includes a spoken alphanumeric character, e.g., a letter, and the at least one visual stimulus includes a displayed string of alphanumeric characters, e.g., letters, for example, seven letters, including a middle letter with repetitive sequences of another letter preceding and succeeding the middle letter, e.g., three Xs, followed by an A, followed by three more Xs. In this exemplary task, the target correspondence or match criterion requires the middle letter in the string to match or correspond to the spoken letter, where the preceding and succeeding letters, referred to as the surrounding letters, may serve to confuse the subject, particularly if the surrounding letters match the spoken letter. For example, in one embodiment, the subject may hear a letter spoken and see a string of seven letters displayed on the screen. The task is to indicate when the spoken letter corresponds with or matches the letter in the middle of the string of letters. As noted above, in one embodiment, the string includes the same letter repeated six times with a different letter displayed in the center. The subject should inhibit their response to the six letters repeated on either side of the middle letter. For example, a string of Xs may appear on either side of an N coincident with the audio presentation of the word “ex”. This is a mismatch requiring the subject to inhibit their response to the six letters on either side of the target letter. Note that numerals may also be used, e.g., the auditory stimulus may be a spoken numeral, and the visual stimulus may be first displayed numeral, surrounded by a string (i.e., repetitive sequence) of a second numeral, e.g., “3335333”. Thus, in various embodiments, the task may utilize strings of alphanumeric characters as desired. In other embodiments, the string of characters may include a first character with multiple instances of a second character displayed before or after, in which case the first character (to be compared with the spoken character) is the last or first character in the string, respectively.

FIG. 6 illustrates an example display of a visual stimulus where an O is surrounded by a string of Zs. Thus, in this case, if the auditory stimulus were a spoken “O” (oh), the subject should indicate correspondence, i.e., a match, but if the auditory stimulus is not a spoken “O”, the subject should refrain from indicating such (or indicate that the stimulus group does not match).

As with the above tasks, in one embodiment, the auditory and visual stimuli may be restricted in form and/or content to some specified set of stimuli. For example, each stimulus in the audio stream may be restricted to a letter, spoken once, and each stimulus in the visual stream may be restricted to letter sequences. Note however, that in different embodiments, any alphanumeric characters may be used as desired.

Task 4: Color of Object Shown is Color Spoken

In another exemplary task (referred to herein as Task 4 for convenience), the stimulus group is multi-modal, where the stimulus group includes at least one auditory stimulus and at least one visual stimulus. In this example task, the at least one auditory stimulus includes a spoken direction, and the at least one visual stimulus includes a displayed graphical arrow with a direction (word) printed within, e.g., “up”, “down”, “left”, or “right”. In this exemplary task, the target correspondence or match criterion requires the direction indicated by the arrow (not the printed word) to match or correspond to the spoken direction, where the printed word may serve to confuse the subject, particularly if the printed word is the same as the spoken direction. For example, in one embodiment, the subject may hear a direction spoken and see an arrow displayed on the screen. The task is to indicate a correspondence when the spoken direction corresponds with or matches the direction in which the arrow points. The subject should inhibit their response to the direction printed (written or displayed) within the arrow. For example, an arrow pointing up with the word “down” printed in the arrow may be presented coincident with the audio presentation of the word “down”, which is a mismatch, thus requiring the subject to inhibit their response to the printed word “down” (or indicate that the stimulus group does not match).

FIG. 7 illustrates an example display of a visual stimulus where an “up” arrow is displayed with the work “left” printed within (thus, corresponding to or matching a spoken “up”). Thus, in this case, if the auditory stimulus were a spoken “up”, the subject should indicate correspondence, i.e., a match, but if the auditory stimulus is not a spoken “up”, the subject should refrain from indicating such (or indicate that the stimulus group does not match).

As with the above tasks, in one embodiment, the auditory and visual stimuli may be restricted in form and/or content to some specified set of stimuli. For example, each stimulus in the audio stream may be restricted to one of the directions: up, down, left, or right, spoken once, and each stimulus in the visual stream may be restricted to a diagram of an arrow pointing up, down, left, or right, with one of the words “up”, “down”, “left”, or “right”, printed within the arrow. Note however, that in different embodiments, any directions may be used as desired.

Task 5: Graphical Elements Match Global Descriptor

In another exemplary task (referred to herein as Task 5 for convenience), the stimulus group is single-modal, where the target correspondence comprises a global shape descriptor, the at least two stimuli comprises an arrangement of graphical elements, and the stimulus group corresponds if the arrangement of graphical elements forms the global shape. In one example of this exemplary single-mode task, the target correspondence may be “global triangle”, and the stimulus group may comprise an arrangement of small shapes, e.g., a plurality of small circles in the shape of a triangle, in which case the stimulus group does correspond in accordance with the target correspondence. In a case where the stimulus group comprises a plurality of small triangles in the shape of a square, the stimulus group would not correspond in accordance with the target correspondence. Note that in various embodiments, the plurality of small shapes may be considered to be a single stimulus (an arrangement of shapes), or may be considered to be multiple stimuli in a stimulus group, where each small shape is from a respective stimulus stream. Stimuli in other single modes are also contemplated, e.g., multiple sounds, melodies, and so forth, as mentioned above.

Thus, in various embodiments, in multi-mode tasks, the at least one auditory stimulus may include a spoken numeral, a spoken color, a spoken letter, or a spoken direction, and the at least one visual stimulus may include a displayed one or more instances of a digit, a displayed color name printed in a color, a displayed first letter, preceded and succeeded by a repetitive sequence of a second letter, a displayed first numeral, preceded and succeeded by a repetitive sequence of a second numeral, or a displayed graphical arrow pointing up, down, left, or right, with the word “up”, “down”, “left”, or “right” printed within. In some embodiments of single-mode tasks, the stimuli in the stimulus groups may correspond to simple or local attributes (e.g., all stimuli are blue), and/or may correspond to global attributes (e.g., stimulus elements form a triangle), as described above. Of course, other single-mode tasks may use any target descriptors and/or stimuli as desired.

In some embodiments, the exercise may include a combination of the above tasks (possibly including other continuous performance tasks, as well). For example, in one embodiment, the presenting (304), and the requiring, determining, and adjusting (306) may compose a session. The repeating 314 (i.e., the repeating of 314 a plurality of times) may include two or more of: performing one or more sessions where the stimulus group comprises at least one auditory stimulus and at least one visual stimulus, where the at least one auditory stimulus comprises a spoken numeral, and the at least one visual stimulus comprises a displayed one or more instances of a digit, and where correspondence of the stimuli comprises the number of instances of the displayed digits matching the spoken numeral; performing one or more sessions where the stimulus group comprises at least one auditory stimulus and at least one visual stimulus, where the at least one auditory stimulus comprises a spoken color, and the at least one visual stimulus comprises a displayed color name printed in a color, and where correspondence of the stimuli comprises the print color matching the spoken color; performing one or more sessions where the stimulus group comprises at least one auditory stimulus and at least one visual stimulus, where the at least one auditory stimulus comprises a spoken letter, and the at least one visual stimulus comprises a displayed first letter, preceded and succeeded by a repetitive sequence of a second letter, and where correspondence of the stimuli comprises the first letter matching the spoken letter; performing one or more sessions where the stimulus group comprises at least one auditory stimulus and at least one visual stimulus, where the at least one auditory stimulus comprises a spoken numeral, and the at least one visual stimulus comprises a displayed first numeral, preceded and succeeded by a repetitive sequence of a second numeral, and where correspondence of the stimuli comprises the first numeral matching the spoken numeral; performing one or more sessions where the stimulus group comprises at least one auditory stimulus and at least one visual stimulus, where the at least one auditory stimulus comprises a spoken direction, and the at least one visual stimulus comprises a displayed graphical arrow pointing up, down, left, or right, with the word “up”, “down”, “left”, or “right” printed within, and where correspondence of the stimuli comprises the displayed graphical arrow matching the spoken direction; or performing one or more sessions where the target correspondence comprises a global shape descriptor, the at least two stimuli comprises an arrangement of graphical elements, and the stimulus group corresponds if the arrangement of graphical elements forms the global shape.

Thus, while some of the above exemplary tasks are multi-modal (auditory and visual), others may use a single mode, as mentioned above. For example, following the last task described above, in one single mode example, the target correspondence may be a global shape descriptor, e.g., “global triangle”, and the stimulus group may comprise an arrangement of graphical elements, e.g., small shapes, e.g., a plurality of small circles in the shape of a triangle, in which case the stimulus group does correspond in accordance with the target correspondence. In the case where the stimulus group comprises a plurality of small triangles in the shape of a square (or circle, etc.), the stimulus group would not correspond in accordance with the target correspondence. Note that in various embodiments, the plurality of small shapes may be considered to be a single stimulus (an arrangement of shapes), or may be considered to be multiple stimuli in a stimulus group, where each small shape is from a respective stimulus stream. Thus, in some embodiments, the target correspondence may comprise a global shape descriptor, where the at least two stimuli comprise an arrangement of graphical elements, and where the stimulus group corresponds if the arrangement of graphical elements forms the global shape.

In some embodiments, the repeating of 314, and/or the performing the repeating of 314 a plurality of times, may occur a specified number of times each day, for a specified number of days. In other words, the subject may perform a plurality of sessions each day over a period of days, e.g., for 6 months, to improve cognition.

In some embodiments, certain information may be maintained and recorded over the course of the exercise. For example, in one exemplary embodiment, the following information may be recorded: the name of the subject; the age of the subject; the gender of the subject; the number of trial groups completed; all scores achieved during the exercise; the conditions in force for each trial group; time/date for each session; and time spent on each trial group, among others. Of course, this information is meant to be exemplary only, and other information may be recorded as desired.

In some embodiments, the method may also include performing one or more practice sessions, i.e., prior to performing the method elements described above. For example, in some embodiments, one or more practice sessions may be performed prior to the beginning of training to familiarize the subject with the nature and mechanisms of the exercise. In some embodiments, in each practice session, a specified number of trials (e.g., 1) for each of one or more practice conditions may be performed. In some embodiments, the subject may be able to invoke such practice sessions at will during the exercise, e.g., to re-familiarize the subject with the task at hand.

Graphical User Interface

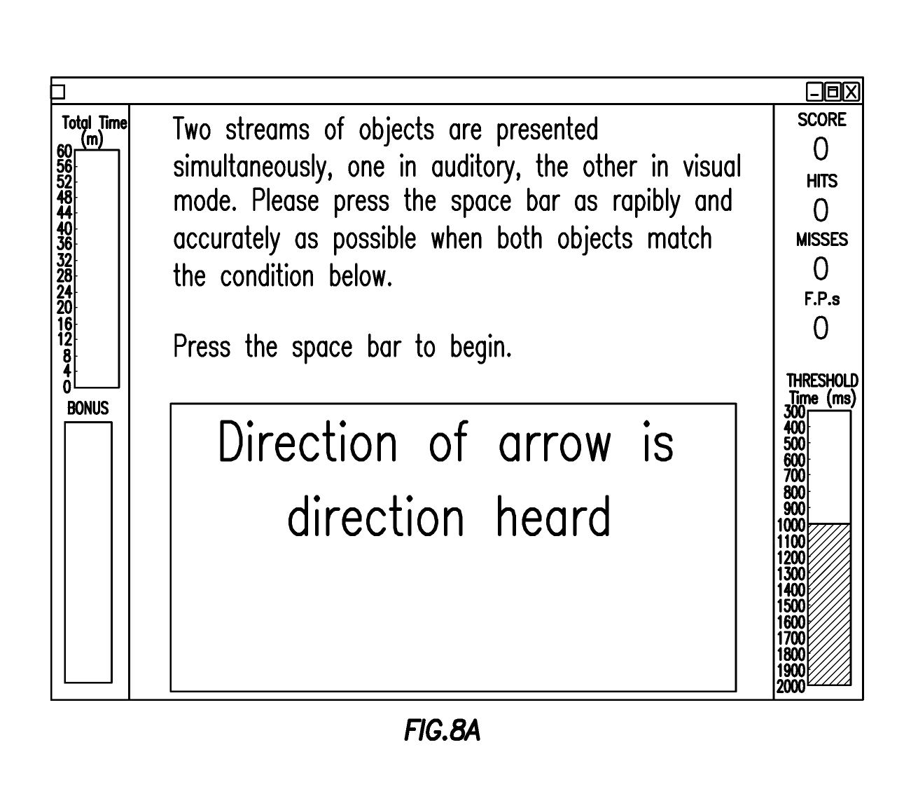

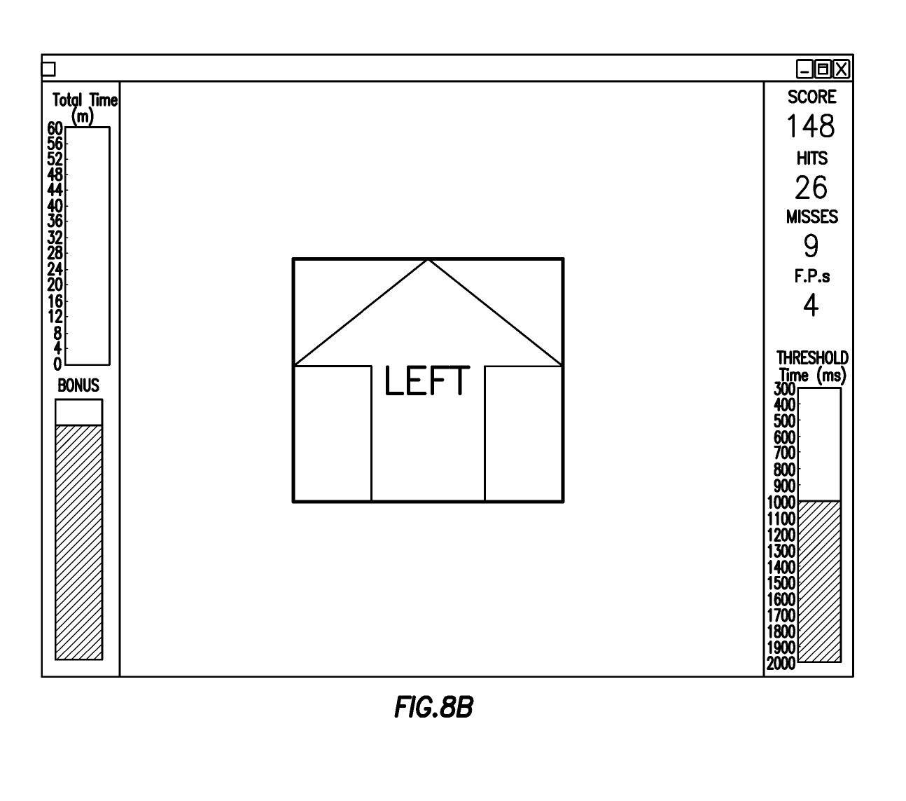

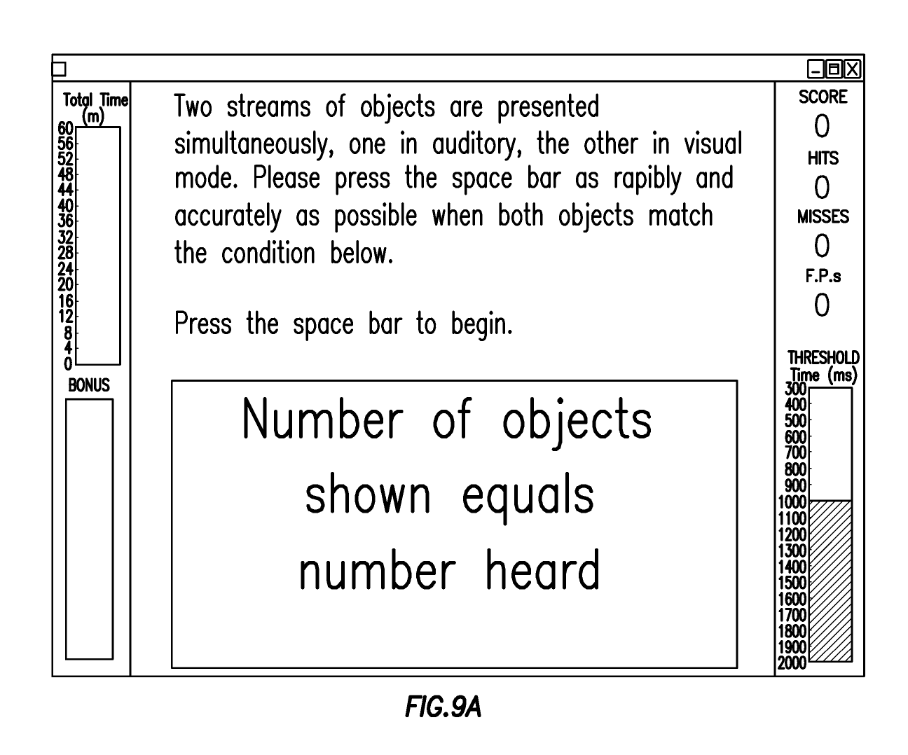

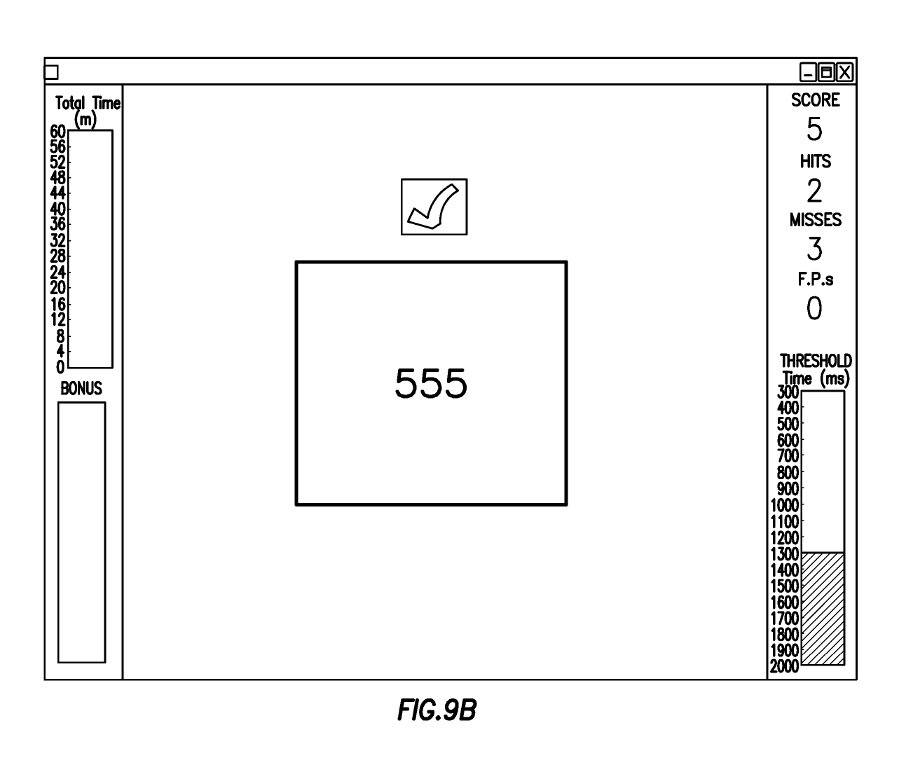

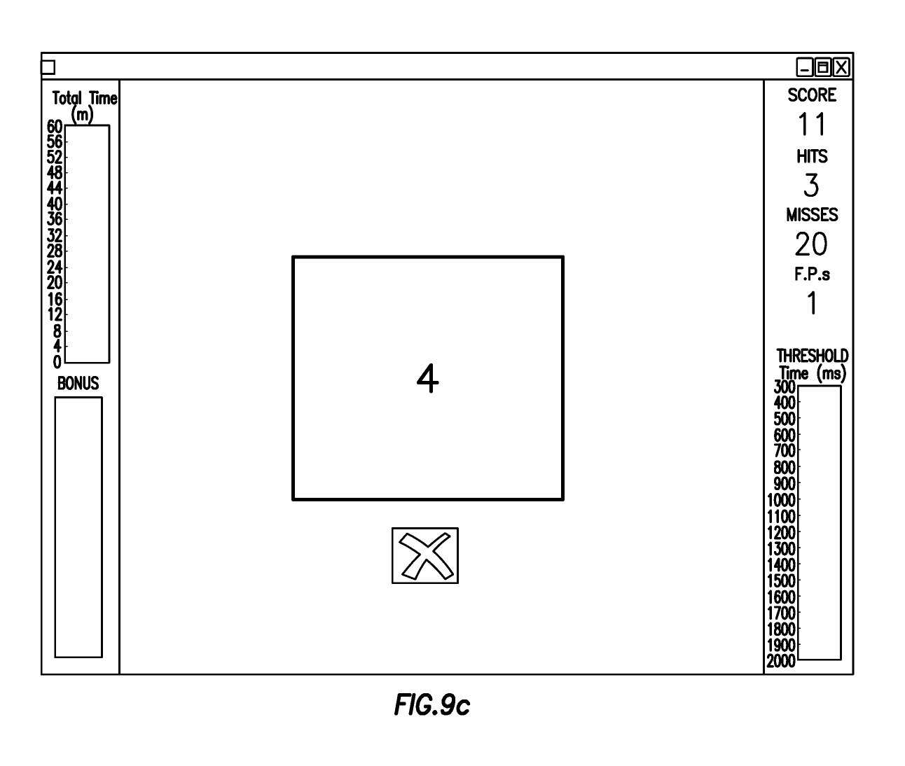

As noted above, in preferred embodiments, the exercise(s) may be performed via a graphical user interface (GUI). Exemplary embodiments of such a GUI are described below with reference to FIGS. 8, 9A and 9B, although it should be noted that the GUI appearance and functionalities described herein are meant to be exemplary only, and are not intended to limit the GUI to any particular form, function, or appearance.

In one embodiment, the GUI may include an introductory screen presenting task-specific instructions to the subject. The user may invoke initiation of the exercise when ready, e.g., by pressing the space bar.

FIG. 8A is a screenshot of an exemplary GUI with instructions and a presented target correspondence, according to one embodiment. As may be seen, in this example, the target correspondence specifies that the stimuli correspond when the direction of a displayed arrow is the direction heard. Thus, for example, a down-pointing arrow would correspond to a spoken “down”, and so forth.

Note that the GUI includes various indicators related to the subject's performance. The indicators shown include a total time indicator, labeled “Total Time”, indicating the time the subject has spent so far in the exercise, a bonus meter or indicator, labeled “BONUS”, that may indicate how close the subject is to achieving a bonus award (e.g., bonus points), a score indicator, labeled “SCORE”, indicating the current points achieved in the exercise, hit and miss indicators, respectively indicating the number of hits (i.e., true positives) and misses (i.e., false negatives), a false positive indicator, labeled “F.P.s”, indicating the number of false positives, and a threshold meter or indicator, labeled “THRESHOLD”, indicating the current value of the duration and/or ISI in the exercise. Of course, in other embodiments, other indicators may be used as desired.

FIG. 8B is a screenshot of an exemplary GUI with a presented stimulus. As may be seen, in this embodiment, the GUI includes a stimulus display area wherein is displayed an up arrow with the word “left” printed within. Thus, according to the target correspondence presented in FIG. 8A, if the auditory stimulus were a spoken “up”, the stimuli would correspond. Note that the displayed “left” is intended to confuse the subject, especially in cases where the auditory stimulus is a spoken “left”. Thus, the subject should ignore the textual direction in the arrow.

In one embodiment, following a specified delay, e.g., 2000 ms, two or more streams of stimuli may be presented continuously, as described above. The duration and ISI of the presentation may be randomly chosen, determined based on prior studies, or based on past performances of the exercise, among other initialization techniques.

The following relates the subject's responses, described above, to aspects of the GUI, particularly the trial-by-trial rewards presented by or via the GUI, according to one embodiment, although it should be noted that these awards are meant to be exemplary only.

Trial-by-Trial Rewards

Hit (true positive): When the subject's response is a hit or true positive, meaning that the subject has correctly indicated that the stimuli in a stimulus group correspond or match, the subject may be rewarded with auditory feedback, e.g., a success sound (e.g., a “ding”), visual feedback (e.g., a graphical success indication), addition of points, and/or bonus meter advances.

Non-response (true negative): When the subject's response is a non-response or true negative, meaning that the subject has correctly refrained from indicating correspondence or matching for the stimulus group, the subject may be rewarded with bonus meter advances, and after five non-responses in a row, may be rewarded with auditory feedback, e.g., a success sound (e.g., a “ding”), visual feedback (e.g., a graphical success indication), and addition of points.

FIG. 9A illustrates a screenshot of an exemplary GUI with instructions and a presented target correspondence, according to one embodiment. As may be seen, in this example, the target correspondence specifies that the stimuli correspond when the number of objects shown equals the number heard. Thus, for example, a displayed sequence of “88888” would correspond to a spoken “five”, since there are five “8”s, and so forth. Note that the value of each digit (“8”) is meant to confuse the subject. Of course, other elements besides digits may be used as desired, e.g., letters, groups of geometric objects, and so forth.

FIG. 9B illustrates an exemplary screenshot of the GUI presenting visual feedback for a correct response, i.e., a hit, or a non-response, in this case, a checkmark presented above the visual stimulus (“555”), although it should be noted that any other visual feedback may be used, in addition to other rewards.

False positive: When the subject's response is a false positive, meaning that the subject has incorrectly indicated that the stimuli in a stimulus group correspond or match, the subject may be rewarded (penalized) with auditory feedback, e.g., an error sound (e.g., a “thunk”), visual feedback (e.g., a graphical indication of error or failure), bonus meter reset (where progress toward a bonus is reset to zero or decreased).

Miss (false negative): When the subject's response is a false negative, meaning that the subject has incorrectly failed to indicate that the stimuli in a stimulus group correspond or match, the subject may be rewarded (penalized) with a bonus meter reset (where progress toward a bonus is reset to zero or decreased), and/or a frame color change, i.e., the GUI may modify the color of the region around the visual stimulus to indicate an error. Other rewards or penalties may be used as desired, e.g., visual feedback, etc.

FIG. 9C illustrates an exemplary screenshot of the GUI presenting visual feedback for an incorrect response. As shown, in this case, the GUI has modified the frame color (around the visual stimulus (“4”)), presented visual feedback in the form of an “X” under the visual stimulus, and reset the bonus meter.

Threshold Determination

As indicated above, the duration and/or ISI may be adjusted using an adaptive procedure. For example, in some embodiments, the duration and/or ISI may be adjusted using a maximum likelihood procedure. Such procedures may be used to modify or set an adjustable attribute (or combination of attributes) of a presented stimulus, whereby trials in the task or exercise may be made more or less difficult. Such an adjustable parameter is generally referred to as a stimulus intensity, and the continuous performance maximum likelihood procedure is used to determine a stimulus threshold, which is the value of the stimulus intensity at which the subject achieves a specified level of success, e.g., 0.9, corresponding to a 90% success rate. There are various approaches whereby such thresholds may be assessed or determined, such as, for example, the well known QUEST (Quick Estimation by Sequential Testing) threshold method, which is an adaptive psychometric procedure for use in psychophysical experiments, or a related method, referred to as the ZEST (Zippy Estimation by Sequential Testing) procedure or method, which is an adaptive psychometric procedure for use in psychophysical experiments, among others. Embodiments of the present invention preferably use continuous performance versions of ZEST or QUEST.

Exercise based threshold determination may be designed to assess a subject's threshold with respect to stimuli on a given exercise, and can be used to adjust stimulus presentation to achieve and maintain a desired success rate for the subject, e.g., with respect to a particular exercise, task, and/or condition. In preferred embodiments of the exercises and tasks described herein, the stimulus intensity is the duration and/or ISI of the presented stimuli. In other words, the progressions (successive modifications or adjustments of presentation parameters, e.g., duration and/or ISI) in the exercise may be calculated using an adaptive procedure, e.g., a maximum likelihood procedure, e.g., the ZEST procedure. For example, for each trial, a likelihood function may be calculated (based on the subject's response) to determine the next best guess of the true threshold. This estimate may be used (and possibly displayed) in the next trial. Based on the trial outcome and all previous trials the next best guess may be calculated and used in the presentation of stimuli for the next trial (and possibly displayed). As the probability function narrows and the standard deviation decreases, the estimate of true threshold approaches the true value—e.g., achieving a “good enough” threshold value. Note that the ZEST procedure is a modification of the QUEST procedure—the ZEST procedure uses the mean while the QUEST procedure uses the mode. In preferred embodiments, when training, a single stair ZEST procedure may be used with a threshold level of 85%, although other values may be used as desired.

In preferred embodiments, the maximum likelihood procedure may be a continuous performance maximum likelihood procedure (as opposed to a discrete performance maximum likelihood procedure), such as a continuous performance ZEST procedure. One such a procedure, referred to as a continuous performance task (CPT), is described below.

Continuous Performance Progression

The Continuous Performance Task (CPT) is a neuropsychological test that consists of a series of stimuli presented one after another. The subject may be instructed to attend to a particular stimulus or a category of stimuli and respond to the presented stimulus. The initial duration of CPT, e.g., the initial value of the presentation time for the stimulus groups, may differ from task to task.

Subject Response

In preferred embodiments, there are four possible response outcomes: true positive, true negative, false positive and false negative, defined as follows:

Correct responses:
True positive: hit or correct response to a correct target
True negative: no response to a non-target

Incorrect responses:
False negative: miss or no response to a correct target
False positive: response to a non-target
   Training at Optimal Level

Continuous Performance Tasks have traditionally been conducted where the stimulus Onset Asynchrony (SOA) time, e.g., the duration plus the ISI, is fixed throughout a session or is only altered after a block of stimuli is presented. Because the appropriate SOA time may differ greatly depending on: 1) the nature of the task; 2) the type of stimulus set used; and 3) the ability of the participant, a progression algorithm that optimizes the training experience is desired, especially when the training of speed of processing is crucial. For example, if the SOA time is too long, the task will not challenge the participants and thus not engage them. If the SOA time is too short, participants may find the task frustrating and the task may lack training value. Thus, a new SOA time progression scheme is presented herein that optimizes training experience by changing the SOA from trial to trial based on a maximum likelihood method. This scheme is used in preferred embodiments of the continuous performance cognitive training exercises described above.

In one embodiment, the progression scheme employed is based on the ZEST (Zippy Estimation by Sequential Testing) Bayesian adaptive estimator method, which is a probabilistic procedure where a prior estimate value of a variable is updated sequentially via a likelihood function that contains all the previous trials' information, yielding a posterior estimate value that encompasses all the data generated so far from the initial assumptions to all the user's responses. In other embodiments, other adaptive procedures may be used, e.g., QUEST.

Psychometric Function

The procedure may begin with a predetermined psychometric function, which describes the relationship between a parameter of a stimulus and the behavior of a person's response about a certain attribute of that stimulus. The psychometric function is generally a sigmoidal function, with the percentage of correct responses plotted against the stimulus parameter.

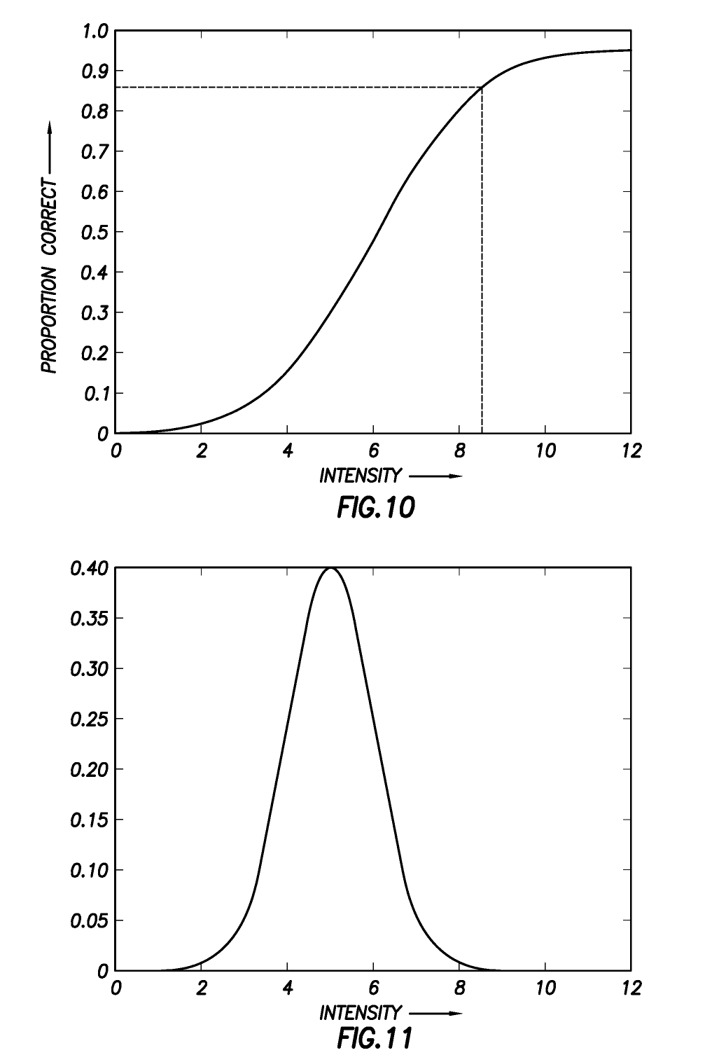

FIG. 10 illustrates an exemplary psychometric function based on a cumulative Gaussian distribution for a detection (yes/no) task with a 5% lapsing rate, and a target performance rate of 85%. In this example, the difficulty of the task decreases as the intensity parameter increases, as shown by the higher percent correct for higher parameter values. The dotted lines, at ˜8.5 intensity and ˜0.85 proportion correct, indicate the correspondence between the intensity parameter and the 85% performance rate.

The method makes several assumptions about the psychophysics:

1. The psychometric function has the same shape, except a shift along the stimulus intensity axis to indicate different performance values.

2. The performance value does not change from trial to trial.

3. Individual trials are statistically independent.

It should be noted, however, that in preferred embodiments, the methods described herein may be robust to violations of these rules, particularly to rules 2 and 3.

Prior Probability Density Function

The prior probability density function (P.D.F.) is the initial distribution of the intensity values that yield the performance level in the psychophysical task. Since the function is a P.D.F., a probability function, it is a nonnegative function with the area under the curve summing up to 1, i.e., the total probability equals 100%. Typical examples of prior P.D.F.s are Gaussian distributions, and rectangular distributions. The initial estimate of intensity is often taken to be the mean of the P.D.F. FIG. 11 illustrates an exemplary probability density function with initial intensity estimate x=5, indicated by the peak of the function.

Likelihood Function

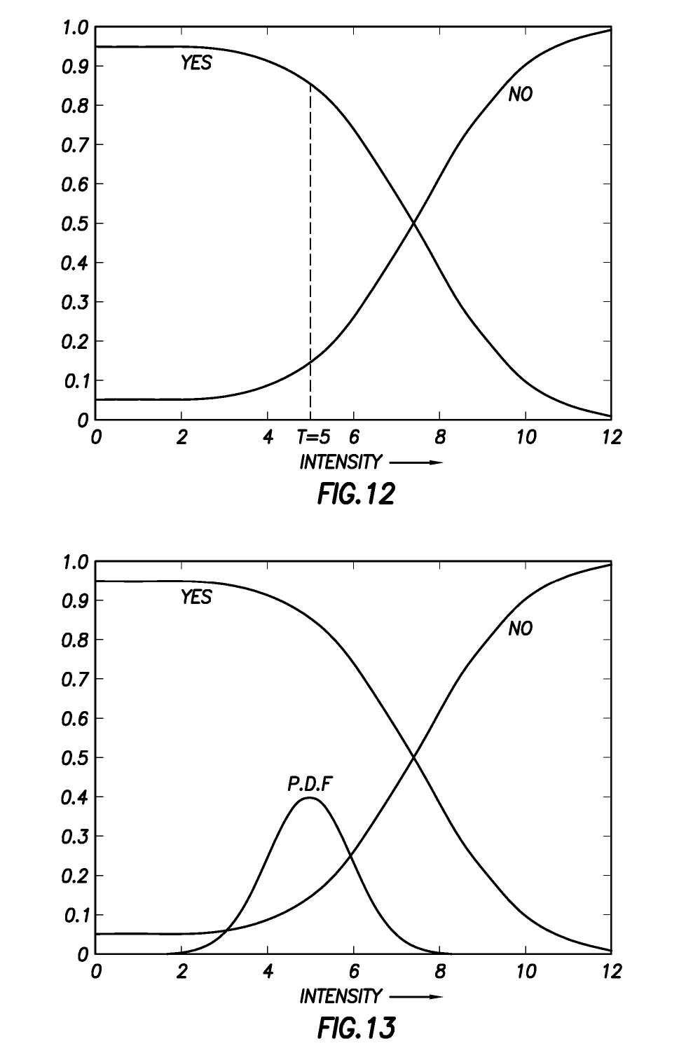

The prior P.D.F. may be adjusted after each trial by one of two likelihood functions, which are the respective probability functions describing the subject's likelihood of responding “yes” or “no” to the stimulus at the intensity as a function of the intensity. Since the psychometric function has a constant shape and the form F(x−T), fixing the intensity x and treating intensity T as the independent variable, the “yes” likelihood, p=F(−(T−x)), is thus the mirror image of the psychometric function about T, and the “no” likelihood function is then simply 1−p. FIG. 12 illustrates exemplary likelihood functions with T=5 and an 85% correct rate, correspondingly labeled “Yes” and “No”.

Posterior Probability Density Function

After a presentation is complete and the response is noted, the prior P.D.F. may be updated using Bayes' rule, by multiplying the prior P.D.F. by the likelihood function corresponding to the subject's response to the trial's stimulus intensity to obtain the posterior P.D.F. The mean of the posterior P.D.F. may then be used as the new intensity estimate. This procedure may be repeated after every presentation to determine the subsequent intensity of the stimulus.

Terminating Condition

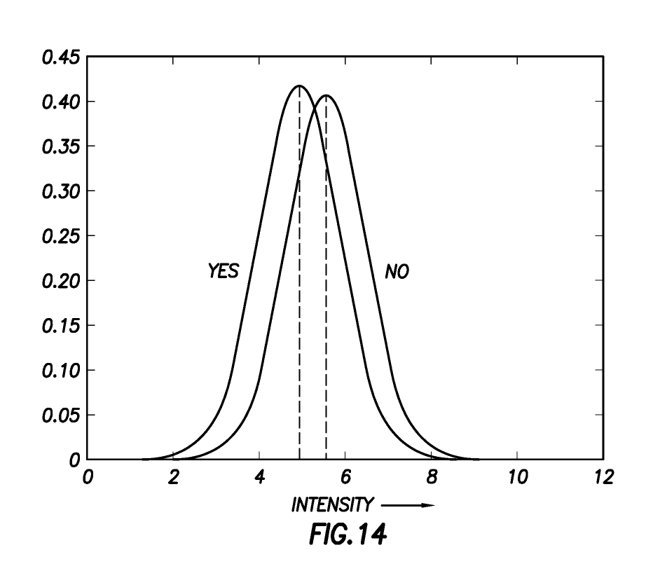

The procedure may be terminated if the posterior P.D.F. satisfies a certain confidence level. This may first require the posterior P.D.F. computed to be normalized. If the confidence interval of the posterior P.D.F. yielding the confidence level is less than the specified length, then the procedure may be terminated, and the final intensity obtained is the threshold intensity. FIG. 13 illustrates an exemplary prior P.D.F. (labeled “P.D.F.”) superimposed with exemplary likelihood functions (again, labeled “Yes” and “No”). FIG. 14 illustrates an exemplary posterior P.D.F. with Yes/No response. Note that the intensity for the respective Yes and No P.D.F. functions differs.

CPT Framework

In one embodiment of the continuous performance framework described herein, illustrated by FIGS. 10-14, an SOA time (represented by intensity) is sought that results in the subject achieving an 85% correct rate, with the initial SOA time set at 5 units. In this example, if the response to the trial is correct, the next SOA time is updated to ˜4.8, while an incorrect response yields subsequent SOA time ˜5.5. This new SOA time may then be used for the presentation duration of the next stimulus in the block or sequence (stream). The procedure may continue in the same fashion for the updated SOA time to yield the subsequent SOA time for the next presentation. Note, however, that these particular values are meant to be exemplary only, and that any other values may be used as desired.

Thus, various embodiments of the methods disclosed herein may utilize a continuous performance maximum likelihood procedure, e.g., continuous performance ZEST, to adaptively modify one or more stimulus presentation parameters, e.g., duration and/or ISI, in continuous performance tasks or exercises utilizing stimulus streams.

It should also be noted that the particular exercises disclosed herein are meant to be exemplary, and that other continuous performance cognitive training exercises using stimulus streams may be used as desired, possibly in combination. In other words, the exercises described herein are but specific examples of cognitive training exercises using a computing system to present stimulus streams to a subject, record the subject's responses, and modify some aspect of the stimuli based on these responses, where these method elements are repeated in an iterative manner using multiple sets of stimuli to improve the subject's cognition. Note particularly that such cognitive training using a variety of such stimulus stream-based exercises or tasks, possibly in a coordinated manner, is contemplated. Thus, various embodiments of the cognitive training exercises and tasks described herein may be used singly or in combination to improve the subject's cognitive skills.

Those skilled in the art should appreciate that they can readily use the disclosed conception and specific embodiments as a basis for designing or modifying other structures for carrying out the same purposes of the present invention without departing from the spirit and scope of the invention as defined by the appended claims. For example, various embodiments of the methods disclosed herein may be implemented by program instructions stored on a memory medium, or a plurality of memory media.

We claim:

1. A computer-implemented method for enhancing cognition in a subject, utilizing a computing device to present stimuli and to receive responses from the subject, the method comprising:
a) providing a set of stimuli for presentation to the subject;
b) presenting a target correspondence to the subject;
c) presenting a continuous sequence of stimulus groups from the set of stimuli to the subject one stimulus group at a time, wherein each stimulus group comprises at least two stimuli, wherein each stimulus group is presented for a specified duration, and wherein the stimulus groups in the continuous sequence of stimulus groups are separated by a specified inter-stimulus-interval (ISI);
d) for each stimulus group in the continuous sequence of stimulus groups,
requiring the subject to respond to the stimulus group by indicating when all the stimuli in a group correspond in accordance with the target correspondence, and by refraining from indicating when all the stimuli in the group do not correspond in accordance with the target correspondence;
determining if the subject responded correctly for the stimulus group; and
adjusting the duration and/or the ISI based on said determining; and
e) repeating b)-d) one or more times in an iterative manner to improve the cognition of the subject.

2. The method of claim 1, wherein b)-d) is performed under a specified condition, wherein the condition specifies one or more attributes of said presenting the continuous sequence of stimulus groups, the method further comprising:
repeating b)-e) a plurality of times in an iterative manner, wherein, for each iteration, b)-e) is performed under a respective condition.

3. The method of claim 2, wherein each condition specifies one or more of:
length of the continuous sequence of stimulus groups;
length of time of said presenting the continuous sequence of stimulus groups;
correspondence frequency, comprising a ratio of stimulus groups in which all the stimuli correspond in accordance with the target correspondence to stimulus groups in which all the stimuli do not correspond in accordance with the target correspondence; or
target/foil confusability, comprising a degree to which stimuli that correspond in accordance with the target correspondence are similar to stimuli that do not correspond in accordance with the target correspondence.

4. The method of claim 1, further comprising:
indicating whether the subject responded correctly, wherein said indicating is performed audibly and/or visually.

5. The method of claim 4, wherein the subject's response to the stimulus group comprises one of:
a correct response, comprising:
a true positive, wherein the subject correctly indicates when all the stimuli in the stimulus group correspond in accordance with the target correspondence; or
a true negative, wherein the subject correctly refrains from indicating when all the stimuli in the stimulus group do not correspond in accordance with the target correspondence; or
an incorrect response, comprising:
a false negative, wherein the subject fails to indicate when all the stimuli in the stimulus group correspond in accordance with the target correspondence; or
a false positive, wherein the subject incorrectly indicates that all the stimuli in the stimulus group correspond in accordance with the target correspondence.

6. The method of claim 5, wherein a true positive comprises the subject correctly indicating when all the stimuli in the stimulus group correspond in accordance with the target correspondence before a next stimulus group is presented.

7. The method of claim 4, wherein said indicating whether the subject responded correctly comprises:
rewarding the subject if a specified level of success is achieved; or
penalizing the subject if a specified level of failure is achieved;
wherein the rewarding and penalizing each comprises one or more of:
auditory feedback;
visual feedback;
point modification; or
change in bonus status.

8. The method of claim 4, further comprising:
terminating said repeating b)-d) if the subject responds incorrectly a specified number of times consecutively.

9. The method of claim 1, wherein b)-d) composes a session, the method further comprising:
presenting a reward to the subject at the end of each session, wherein the reward is presented visually and/or audibly.

10. The method of claim 1, wherein the adaptive procedure comprises a continuous performance maximum likelihood procedure.

11. The method as recited in claim 10, wherein the continuous performance maximum likelihood procedure comprises one or more of:
a continuous performance QUEST (quick estimation by sequential testing) threshold procedure; or
a continuous performance ZEST (zippy estimation by sequential testing) threshold procedure.

12. The method of claim 1, wherein said adjusting the duration and/or the ISI comprises:
adjusting the duration and/or the ISI to approach and substantially maintain a specified success rate for the subject.

13. The method of claim 12, wherein said adjusting the duration and/or the ISI to approach and substantially maintain a specified success rate for the subject uses a single stair maximum likelihood procedure.

14. The method of claim 1, wherein b)-d) compose a session, and wherein for each session, an initial value of the duration and/or the ISI and a final value of the duration and/or the ISI are averaged to determine the initial value of the duration and/or the ISI for the next session.

15. The method of claim 1, wherein b)-d) compose a session, the method further comprising:
for each session, averaging reaction times for each stimulus group in the continuous sequence of stimulus groups to determine a minimum value for the duration and/or the ISI for the next session, wherein each reaction time comprises a respective delay between the presentation of each stimulus group in which all the stimuli correspond in accordance with the target correspondence and the subject's response to the stimulus group.

16. The method of claim 1, wherein each stimulus group presentation and corresponding subject response composes a trial, the method further comprising:
for each trial, recording one or more of:
the stimulus group;
whether or not all the stimuli in the stimulus group correspond in accordance with the target correspondence;
the duration;
the ISI;
the subject's response;
the correctness or incorrectness of the subject's response;
a reaction time for the trial, comprising the delay between the presentation of each stimulus group in which all the stimuli correspond in accordance with the target correspondence and the subject's response to the stimulus group; or
statistical measures for the adaptive procedure.

17. The method of claim 1, wherein the target correspondence specifies a correspondence condition for at least a subset of the stimulus groups in the continuous sequence of stimulus groups.

18. The method of claim 1, wherein b)-d) compose a session, the method further comprising:
performing an initial session prior to performing b)-d), wherein the initial session comprises b)-d), but wherein, in performing d) in the initial session, neither the duration nor the ISI is adjusted.

19. The method of claim 1, wherein the stimulus group comprises at least one auditory stimulus and at least one visual stimulus.

20. The method of claim 19,
wherein the at least one auditory stimulus comprises:
a spoken numeral;
a spoken color;
a spoken letter; or
a spoken direction; and
wherein the at least one visual stimulus comprises:
a displayed numeral;
a displayed letter;
a displayed color name printed in a color;
a displayed first letter, preceded and/or succeeded by a repetitive sequence of a second letter;
a displayed first numeral, preceded and/or succeeded by a repetitive sequence of a second numeral; or
a displayed graphical arrow pointing up, down, left or right, with the word up, down, left or right printed within.

21. The method of claim 1,
wherein the target correspondence comprises a global shape descriptor;
wherein the at least two stimuli comprises an arrangement of graphical elements; and
wherein the stimulus group corresponds if the arrangement of graphical elements forms the global shape.

22. The method of claim 1, wherein the stimuli in the stimulus group are presented in a single mode, wherein the single mode comprises one of:
auditory;
visual;
orthographic; or
pictorial.

23. The method of claim 1, wherein the stimuli in the stimulus group are presented in multiple modes, comprising two or more of:
auditory;
visual;
orthographic; or
pictorial.

24. The method of claim 1, wherein b)-c) composes a session, the method further comprising:
repeating b)-e) a plurality of times in an iterative manner, wherein said repeating comprises two or more of:
performing one or more sessions wherein:
the stimulus group comprises at least one auditory stimulus and at least one visual stimulus;
the at least one auditory stimulus comprises:
a spoken numeral; and
the at least one visual stimulus comprises:
a displayed numeral;
performing one or more sessions wherein:
the stimulus group comprises at least one auditory stimulus and at least one visual stimulus;
the at least one auditory stimulus comprises:
a spoken letter; and
the at least one visual stimulus comprises:
a displayed letter;
performing one or more sessions wherein:
the stimulus group comprises at least one auditory stimulus and at least one visual stimulus;
the at least one auditory stimulus comprises:
a spoken color; and
the at least one visual stimulus comprises:
a displayed color name printed in a color;
performing one or more sessions wherein:
the stimulus group comprises at least one auditory stimulus and at least one visual stimulus;
the at least one auditory stimulus comprises:
a spoken letter; and
the at least one visual stimulus comprises:
a displayed first letter, preceded and/or succeeded by a repetitive sequence of a second letter;
performing one or more sessions wherein:
the stimulus group comprises at least one auditory stimulus and at least one visual stimulus;
the at least one auditory stimulus comprises:
a spoken numeral; and
the at least one visual stimulus comprises:
a displayed first numeral, preceded and/or succeeded by a repetitive sequence of a second numeral; and/or
performing one or more sessions wherein:
the stimulus group comprises at least one auditory stimulus and at least one visual stimulus;
the at least one auditory stimulus comprises:
a spoken direction; and
the at least one visual stimulus comprises:
a displayed graphical arrow pointing up, down, left or right, with the word up, down, left or right printed within; or
performing one or more sessions wherein:
the target correspondence comprises a global shape descriptor;
the at least two stimuli comprises an arrangement of graphical elements; and
the stimulus group corresponds if the arrangement of graphical elements forms the global shape.

25. The method of claim 1, further comprising:
repeating b)-e) a plurality of times in an iterative manner, wherein said repeating b)-e) occurs a specified number of times each day, for a specified number of days.

26. A computer accessible memory medium comprising program instructions for enhancing cognition in a subject, utilizing a computing device to present stimuli and to receive responses from the subject, wherein the program instructions are executable by a processor to perform:
a) providing a set of stimuli for presentation to the subject;
b) presenting a target correspondence to the subject;
c) presenting a continuous sequence of stimulus groups from the set of stimuli to the subject one stimulus group at a time, wherein each stimulus group comprises at least two stimuli, wherein each stimulus group is presented for a specified duration, and wherein the stimulus groups in the continuous sequence of stimulus groups are separated by a specified inter-stimulus-interval (ISI);
d) for each stimulus group in the continuous sequence of stimulus groups,
requiring the subject to respond to the stimulus group by indicating when all the stimuli in a group correspond in accordance with the target correspondence, and by refraining from indicating when all the stimuli in the group do not correspond in accordance with the target correspondence;
determining if the subject responded correctly for the stimulus group; and
adjusting the duration and/or the ISI based on said determining; and
e) repeating b)-d) one or more times in an iterative manner to improve the cognition of the subject.

27. The memory medium of claim 26, wherein b)-d) is performed under a specified condition, wherein the condition specifies one or more attributes of said presenting the continuous sequence of stimulus groups, the method further comprising:
repeating b)-e) a plurality of times in an iterative manner, wherein, for each iteration, b)-e) is performed under a respective condition.
